(19) United States
(12) Patent Application Publication
(10) Pub. No.: US 2025/0393050 A1
(43) Pub. Date: Dec. 25, 2025

(54) METHOD, DEVICE AND COMPUTER READABLE MEDIUM OF COMMUNICATION

(71) Applicant: NEC Corporation, Tokyo (JP)

(72) Inventors: Peng GUAN, Beijing (CN); Yukai GAO, Beijing (CN); Gang WANG, Beijing (CN)

(73) Assignee: NEC Corporation, Tokyo (JP)

(21) Appl. No.: 18/879,515

(22) PCT Filed: Jun. 29, 2022
(86) PCT No.: PCT/CN2022/102465

§ 371 Date: Dec. 27, 2024

(51) Int. Cl. H04W 72/23; H04B 7/06; H04L 27/26; H04W 52/14; H04W 74/0833

(52) U.S. Cl. CPC H04W 72/23; H04B 7/06968; H04L 27/261; H04W 52/146; H04W 74/0833

(57) ABSTRACT

Embodiments of the present disclosure relate to method, device and computer readable medium of communication. A terminal device receives a first configuration of a SRS transmission and a second configuration of a PUSCH transmission. If a first indication indicating TCI states and a second indication indicating PC information are received, the terminal device determines one of the first and second indications for use in PC, and determines first transmission power for the PUSCH transmission based on the first and second configurations and the one of the first and second indications. In this way, UL PC within a unified TCI framework is achieved.

### TECHNICAL FIELD

Example embodiments of the present disclosure generally relate to the field of telecommunication and in particular, to methods, devices, and computer readable media of communication for uplink (UL) power control (PC) for multiple transmission reception points (MTRP).

### BACKGROUND

Currently, it is proposed to specify extension of a unified transmission configuration indicator (TCI) framework for indication of multiple downlink (DL) and UL TCI states focusing on MTRP use case. It is also proposed to study PC for UL single downlink control information (DCI) for MTRP operation where the extension of the unified TCI framework is assumed. Further, two power limitation assumptions for simultaneous transmission across multi-panels (STxMP) are discussed, i.e., power limitation per panel for STxMP and a total power limitation per user equipment (UE) over all UE panels used for STxMP. However, how to perform UL PC for these scenarios is still incomplete and needs to be further developed.

### SUMMARY

In general, example embodiments of the present disclosure provide methods, devices and computer storage media of communication for UL PC for MTRP.

In a first aspect, there is provided a method of communication. The method comprises: receiving, at a terminal device, a first configuration of a sounding reference signal (SRS) transmission and a second configuration of a physical uplink shared channel (PUSCH) transmission; in accordance with a determination that a first indication indicating active TCI states and a second indication indicating power control information are received, determining one of the first indication and the second indication for use in power control; and determining first transmission power for the PUSCH transmission based on the first and second configurations and the one of the first indication and the second indication.

In a second aspect, there is provided a method of communication. The method comprises: transmitting, at a network device, a first configuration of a SRS transmission and a second configuration of a PUSCH transmission; transmitting a first indication indicating active TCI states and a second indication indicating power control information; and receiving the PUSCH transmission transmitted with first transmission power, the first transmission power being determined based on the first and second configurations and the one of the first indication and the second indication.

In a third aspect, there is provided a method of communication. The method comprises: receiving, at a terminal device deployed with first and second panels, an indication of simultaneous transmission over the first and second panels; determining first transmission power for an uplink transmission based on at least one power limitation for the first and second panels; determining second transmission power for a reference signal transmission based on the at least one power limitation, the first transmission power and a ratio of a power related parameter between the uplink transmission and the reference signal transmission, the ratio being determined based on the at least one power limitation; and performing the uplink transmission with the first transmission power and the reference signal transmission with the second transmission power.

In a fourth aspect, there is provided a device of communication. The device comprises a processor configured to perform the method according to the first or second or third aspect of the present disclosure.

In a fifth aspect, there is provided a computer readable medium having instructions stored thereon. The instructions, when executed on at least one processor, causing the at least one processor to perform the method according to the first or second or third aspect of the present disclosure.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A illustrates an example communication network in which embodiments of the present disclosure can be implemented;

FIG. 1B illustrates another example communication network in which embodiments of the present disclosure can be implemented;

FIG. 1C illustrates still another example communication network in which embodiments of the present disclosure can be implemented;

FIG. 1D illustrates an example scenario of PC related configurations in which embodiments of the present disclosure can be implemented;

FIG. 2 illustrates a schematic diagram illustrating a process of communication for UL PC within a unified TCI framework according to some example embodiments of the present disclosure;

FIG. 3A illustrates an example scenario of application timing according to some embodiments of the present disclosure;

FIG. 3B illustrates another example scenario of application timing according to some embodiments of the present disclosure;

FIG. 3C illustrates another example scenario of application timing according to some embodiments of the present disclosure;

FIG. 3D illustrates another example scenario of application timing according to some embodiments of the present disclosure;

FIG. 4 illustrates a schematic diagram illustrating a process of communication for UL PC for STxMP according to some example embodiments of the present disclosure;

FIG. 5 illustrates a flowchart of an example method performed by a terminal device in accordance with some embodiments of the present disclosure;

FIG. 6 illustrates a flowchart of an example method performed by a network device in accordance with some embodiments of the present disclosure;

FIG. 7 illustrates a flowchart of another example method performed by a terminal device in accordance with some embodiments of the present disclosure; and

FIG. 8 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Small Data Transmission (SDT), mobility, Multicast and Broadcast Services (MBS), positioning, dynamic/flexible duplex in commercial networks, reduced capability (RedCap), Space bome vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), Network-controlled Repeaters, and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The network device may have the function of network energy saving, Self-Organizing Networks (SON)/Minimization of Drive Tests (MDT). The terminal may have the function of power saving.

The embodiments of the present disclosure may be performed in test equipment, e.g. signal generator, signal analyzer, spectrum analyzer, network analyzer, test terminal device, test network device, channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device.

In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As mentioned above, how to perform UL PC within a unified TCI framework for MTRP is still incomplete and how to perform UL PC for STxMP considering different power limitation assumptions is also still incomplete.

In view of this, embodiments of the present disclosure provide solutions of communication for UL PC so as to overcome the above or other potential issues. In one solution, if a terminal device receives an indication (for example, a TCI field in DCI) indicating active TCI states and another indication (for example, a SRS resource indicator (SRI) field in another DCI) indicating PC information, the terminal device determines one of the first indication and the second indication for use in PC. In this way, suitable UL power determination may be attained.

In another solution, in response to receiving a STxMP indication, a terminal device deployed with multiple panels determines transmission power (for convenience, also referred to as first transmission power herein) for an uplink transmission based on at least one power limitation for the multiple panels. Further, the terminal device determines a ratio of a power related parameter between the uplink transmission and a reference signal transmission based on the at least one power limitation and determines transmission power (for convenience, also referred to as second transmission power herein) for the reference signal transmission based on the ratio, the at least one power limitation and the transmission power for the uplink transmission. Then the terminal device performs the uplink transmission with the first transmission power and the reference signal transmission with the second transmission power. In this way, UL power may be correctly determined and suitable UL power control may be attained.

Principles and implementations of the present disclosure will be described in detail below with reference to the figures.

In the present disclosure, some terms may refer to same or similar physical meaning and may be used interchangeably. Some exemplary examples are listed as below.
The terms “port(s) used for a uplink transmission”, “port(s) used for a PUSCH transmission”, “port(s) with non-zero PUSCH transmission power” and “port(s) with non-zero uplink transmission power” can be used interchangeably;
The terms “panel(s) used for a uplink transmission”, “panel (s) used for a PUSCH transmission”, “panel(s) with non-zero PUSCH transmission power” and “panel(s) with non-zero uplink transmission power” can be used interchangeably;
The terms “transmission capability information”, “UE capability information”, “capability-related information”, “capability value set”, “panel information” and “panel-related information” can be used interchangeably;
The terms “precoder”, “precoding”, “precoding matrix”, “beam”, “spatial relation information”, “spatial relation info”, “precoding information”, “precoding information and number of layers”, “precoding matrix indicator (PMI)”, “precoding matrix indicator”, “transmission precoding matrix indication”, “precoding matrix indication”, “TCI state”, “transmission configuration indicator”, “quasi co-location (QCL)”, “quasi-co-location”, “QCL parameter”, “QCL assumption”, “QCL relationship” and “spatial relation” can be used interchangeably;
The terms “single TRP”, “single TCI state”, “single TCI”, “S-TCI”, “single control resource set (CORESET)”, “single CORESET pool”, “S-TRP” and “S-TCI state” can be used interchangeably;
The terms “multiple TRPs”, “multiple TCI states”, “multiple CORESETs” and “multiple control resource set pools”, “multi-TRP”, “multi-TCI state”, “multi-TCI”, “multi-CORESET” and “multi-control resource set pool”, “MTRP” and “M-TCI”, “M-TPR” can be used interchangeably;
The terms “resource(s)”, “resource(s) in a resource set”, “resource set” can be used interchangeably; and
The terms “group”, “subset”, “set” can be used interchangeably.
Further, one panel discussed herein refers to one or more antenna elements deployed at a certain area of a terminal device. A panel discussed herein can refer to downlink panel, uplink panel, panel type, panel status, capability value set, reference signal (RS) resource, RS resource set, antenna port, antenna port group, beam, beam group. In this regard, the terms (and their equivalent expressions) “panel”, “panel type”, “set of antenna port(s)”, “antenna element(s)”, “antenna array(s)” can be used interchangeably.
In addition, panel information discussed herein can refer to UE panel index/identification (ID), downlink panel ID, uplink panel ID, panel type indication, panel status indication, capability value set index, RS resource ID, RS resource set ID, antenna port ID, antenna port group ID, beam ID, beam group ID. The term “per panel” may be interchangeably used with “per capability value index”, “per capability value set index”, “per RF Chain”, “per Tx RF Chain”, “per branch”, “per Tx branch”, etc.
As used herein, the term “TRP” refers to an antenna array (with one or more antenna elements) available to the network device located at a specific geographical location. Although some embodiments of the present disclosure are described with reference to a scenario of multi-TRPs (or a scenario of single TRP) for example, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below.
As used herein, the term “SRS transmission” refers to a transmission of SRS resource identified by SRS signal resource indicator (SRI) in a DCI message for uplink grant. Accordingly, term “the latest SRS transmission” refers to the latest transmission of SRS resource identified by SRI in a DCI message for uplink grant.
As used herein, the term “network”/“network device(s)” refer to one or more network devices. Accordingly, terms “network”, “network device(s)” and “one or more network devices” can be used interchangeably.
‘Panel with lower capability’ can be used interchangeably with ‘panel with higher capability’, ‘panel corresponds to lower/higher capability value set index’, ‘panel used most recently’, ‘[old] panel used in initial access/least PRACH’ and so on. In other words, it can be any pre-defined rule known at both NW and UE side, or signaled by NW/UE to each other by configuration/capability reporting/request.
“BWP ID/index” can be used interchangeably with “BWP/CC ID/index”, “CC identity/index”, “cell identity/index” “, “physical cell identity/index” and “serving cell identity/index”.

### Example of Communication Environment

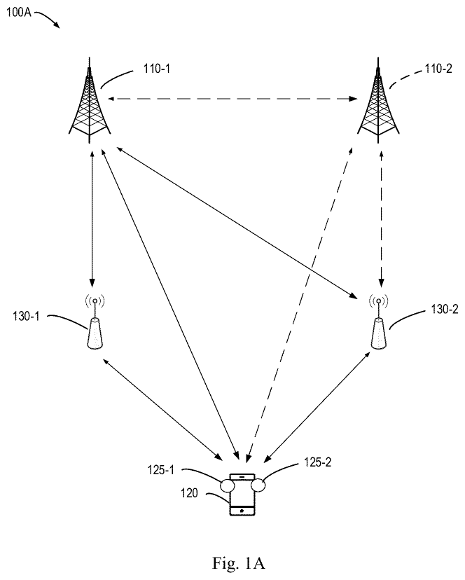

FIG. 1A illustrates an example communication network 100A in which embodiments of the present disclosure can be implemented. The communication network 100A includes a network device 110-1 and an optionally network device 110-2 (collectively or individually referred to as network devices 110). The network device 110 can provide services to a terminal device 120. For purpose of discussion, the network device 110-1 is referred to as the first network device 110-1, and the network device 110-2 is referred to as the second network device 110-2. Further, the first network device 110-1 and the second network device 110-1 can communicate with each other.

In the communication network 100A, a link from the network devices 110 (such as, a first network device 110-1 or the second network device 110-2) to the terminal device 120 is referred to as a downlink, while a link from the terminal device 120 to the network devices 110 (such as, a first network device 110-1 or the second network device 110-2) is referred to as an uplink. In downlink, the first network device 110-1 or the second network device 120-1 is a transmitting (Tx) device (or a transmitter) and the terminal device 120 is a receiving (Rx) device (or a receiver). In uplink, the terminal device 120 is a transmitting Tx device (or a transmitter) and the first network device 110-1 or the second network device 110-2 is a Rx device (or a receiver).

In some embodiments, the network device(s) 110 and the terminal device 120 may communicate with direct links/channels.

In some embodiments, the terminal device 120 may be deployed with more than one panel. As illustrated in FIG. 1A, the terminal device 120 is deployed with panels 125-1 and 125-2. In the following, the panels 125-1 and 125-2 may be referred to as the first panel 125-1 and the second panel 125-2, respectively.

In some embodiments, the first panel 125-1 and the second panel 125-2 correspond to different sets of antenna port(s)/antenna element(s)/antenna array(s). As one specific example, the first panel 125-1 corresponds to a first set of antenna ports and the second panel 125-2 corresponds to a second set of antenna ports. In some embodiments, the panels 125-1 and 125-2 may correspond to different capability value sets, respectively.

In the communication network 100A, a PUSCH STxMP may be supported. Specifically, the terminal device 120 may perform a PUSCH over both of the panels 125-1 and 125-2 simultaneously.

In some embodiments, a MTRP transmission may also be supported. As illustrated in FIG. 1A, the terminal device 120 may communicate with two TRPs, i.e., the TRPs 130-1 and 130-2 (collectively or individually referred to as TRP 130). For purpose of discussion, the TRP 130-1 is referred to as the first TRP 130-1, and the TRP 130-2 is referred to as the second TRP 130-2.

In addition, in order to support MTRP and/or multi-panel, the network device 110 may be equipped with one or more TRPs. For example, the network device 110 may be coupled with multiple TRPs in different geographical locations to achieve better coverage. In one specific example embodiment, the first network device 110-1 is equipped with the first TRP 130-1 and the second TRP 130-2. Alternatively, in another specific example embodiment, the first network device 110-1 and the second network device 110-2 are equipped with the first TRP 130-1 and the second 130-2, respectively.

In some embodiments, the first TRP 130-1 and the second TRP 130-2 are associated with different control resource set pools (CORESET pools). For example, the first TRP 130-1 is associated with a first control resource set pool while the second TRP 130-2 is associated with a second control resource set pool.

Further, both a single TRP mode transmission and MTRP transmission may be supported by the specific example of FIG. 1A. Specifically, in case of the single TRP mode, the terminal device 120 communicates with the network via the first TRP 130-1/second TRP 130-2. Alternatively, in case of the MTRP mode, the terminal device 120 communicates with the network via both of the first TRP 130-1 and the second TRP 130-2.

As one specific example embodiment, during a PUSCH STxMP, the terminal device 120 communicates with the first TRP 130-1 via panel 125-1 and communicates with the second TRP 130-2 via panel 125-2 simultaneously.

Further, the network device(s) 110 may provide one or more serving cells and the first TRP 130-1 and the second TRP 130-2 may be included in a same serving cell or different serving cells. In other words, both an inter-cell transmission and an intra-cell transmission are supported by the specific example of FIG. 1A.

FIG. 1B shows an example scenario of the communication network 100A as shown in FIG. 1A. In the specific example of FIG. 1B, the first TRP 130-1 and the second TRP 130-2 are included in a same serving cell 140. In this event, the MTRP transmission is performed as an intra-cell transmission.

FIG. 1C shows another example scenario of the communication network 100A as shown in FIG. 1A. In the specific example of FIG. 1C, the first TRP 130-1 and the second TRP 130-2 are included in different serving cells 140-1 and 140-2. In this event, the MTRP transmission is performed as an inter-cell transmission.

The communications in the communication network 100A may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols.

It is to be understood that the numbers of elements (i.e., the terminal device 120, the panel 125, the network device 110, the TRP 130 and the cell 140) and their connection relationships and types shown in FIGS. 1A to 1C are only for purpose of illustration without suggesting any limitation. The communication network 100A may include any suitable numbers of elements adapted for implementing embodiments of the present disclosure.

As known, a unified TCI state may provide a reference signal (RS) to determine QCL relationship, Tx beam, Uplink-powerControl and path loss reference signal (PL RS). Types ofunified TCI states may comprise DL and UL respectively or jointly. Alternatively, types of unified TCI states may comprise DLorJoint, and UL. Uplink-powerControl may further provide power control parameter settings such as P0, alpha, closedLooplndex for PUSCH, PUCCH, SRS respectively.

In some embodiments, the terminal device 120 may receive, from the network device 110, DCI comprising a TCI field that indicates multiple TCI states. The multiple TCI states may be associated with respective CORESET or CORESET group or search space sets (i.e., respective TRPs). Each TCI state may provide an UL power control parameter setting and a PL RS. Alternatively, each TCI state may not provide an UL power control parameter setting and a PL RS. In this case, how to select one TCI state from the multiple TCI states is unclear and how to determine applied power control parameter setting and/or PL RS if not provided is also unclear.

In some scenarios, the terminal device 120 may receive, from the network device 110, a configuration for PUSCH transmission comprising power control adjustment states for PUSCH transmission. In some scenarios, the terminal device 120 may receive, from the network device 110, a configuration for SRS transmission comprising power control adjustment states for a SRS resource set. In some embodiments, a TCI state may be applied to a SRS resource. In some embodiments, a TCI state may be not applied to a SRS resource. In some embodiments, a RRC information element (IE) UseIndicatedTCIState may be provided for a SRS resource set. In some embodiments, a RRC IE UseIndicatedTCIState may be not provided for a SRS resource set. In some embodiments, power control adjustment states for a SRS resource set may be same to power control adjustment states for a PUSCH transmission. In some embodiments, power control adjustment states for a SRS resource set may be different from power control adjustment states for a PUSCH transmission. In this case, how to determine UL power for a SRS transmission is unclear.

For a PRACH transmission, a TCI field may be not comprised in a PDCCH order (DCI format 1-0) triggering the PRACH transmission. In this case, how to determine UL power for a PRACH transmission is also unclear.

In some scenarios, the terminal device 120 may receive, from the network device 110, DCI comprising one or more SRI fields that indicate one or more power control configurations. A power control configuration may provide Tx power and a Tx beam or precoder for each TRP. The power control configurations may be the same to or different from that provided via a unified TCI framework.

FIG. 1D illustrates an example scenario 100D of PC related configurations in which embodiments of the present disclosure can be implemented. In the example of FIG. 1D, at a timing T1, a terminal device may receive a configuration for PUSCH transmission comprising one or more power control configurations (e.g., SRI-PUSCH-PowerControl).

As shown in FIG. 1D, at a timing T2, the terminal device may receive DCI for beam indication change of beam, and the DCI comprises one or more TCI fields. As indicated by reference sign 151, the one or more TCI fields may indicate a first TCI state and a second TCI state. The first TCI state may comprise a first UL PC parameter setting, a first PL RS and a first Tx beam. A first Tx power may be determined based on the first UL PC parameter setting and the first PL RS. A first PUSCH transmission may be transmitted to a first TPR based on the first Tx power and the first Tx beam. The second TCI state may comprise a second UL PC parameter setting, a second PL RS and a second Tx beam. A second Tx power may be determined based on the second UL PC parameter setting and the second PL RS. A second PUSCH transmission may be transmitted to a second TPR based on the second Tx power and the second Tx beam.

Continue to refer to FIG. 1D, at timing T3, the terminal device may receive DCI scheduling a PUSCH transmission at timing T4, and the DCI comprises one or more SRI fields. A SRI field may indicate one power control configuration (e.g., SRI-PUSCH-PowerControl) comprised in the configuration of PUSCH transmission. As indicated by reference sign 152, the one or more SRI fields may comprise a first SRI indicating a first SRI-PUSCH-PowerControl and a first SRS resource and a second SRI indicating SRI-PUSCH-PowerControl and a second SRS resource. The first SRI-PUSCH-PowerControl may comprise a first UL PC parameter setting and a first PL RS. The first SRS resource may indicate a first Tx beam and a first Tx precoder. A first Tx power may be determined based on the first UL PC parameter setting and the first PL RS. A first PUSCH transmission may be transmitted to a first TPR based on the first Tx power, the first Tx beam and the first Tx precoder. The second SRI-PUSCH-PowerControl may comprise a second UL PC parameter setting and a second PL RS. The second SRS resource may indicate a second Tx beam and a second Tx precoder. A second Tx power may be determined based on the second UL PC parameter setting and the second PL RS. A second PUSCH transmission may be transmitted to a second TPR based on the second Tx power, the second Tx beam and the second Tx precoder.

In this case, it is unclear whether the PUSCH transmission at timing T4 is performed based on the procedure as indicated by reference sign 151 or 152.

Further, due to different power limitation assumptions, impact of maximum power according to UE power class on UL PC may need to be updated. In addition, DMRS power and PTRS power boosting are all based on “unused power” on those resource elements (REs) not used for data transmission. However in STxMP, due to different power limitation assumptions, those “unused power” may or may not be able to be used to boost DMRS power and PTRS power.

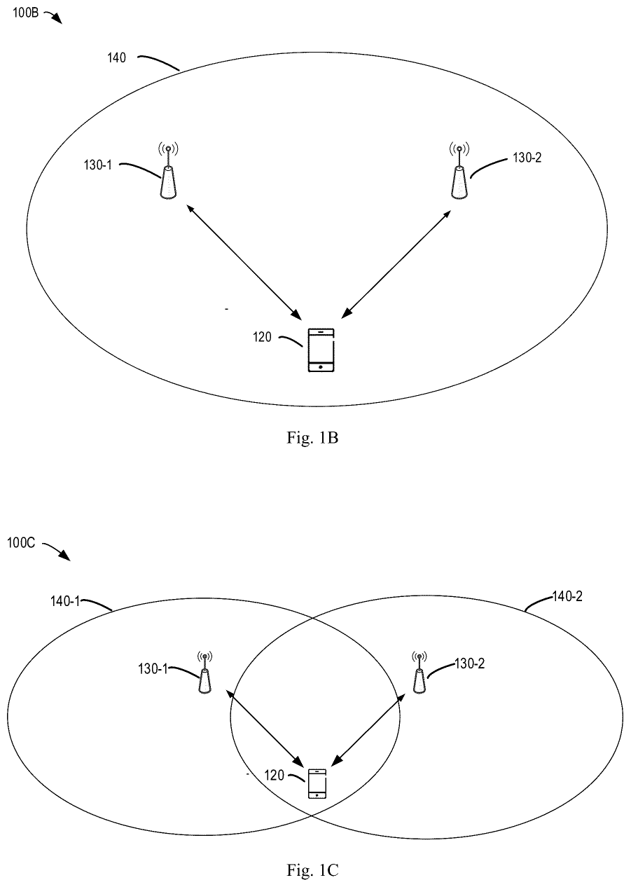

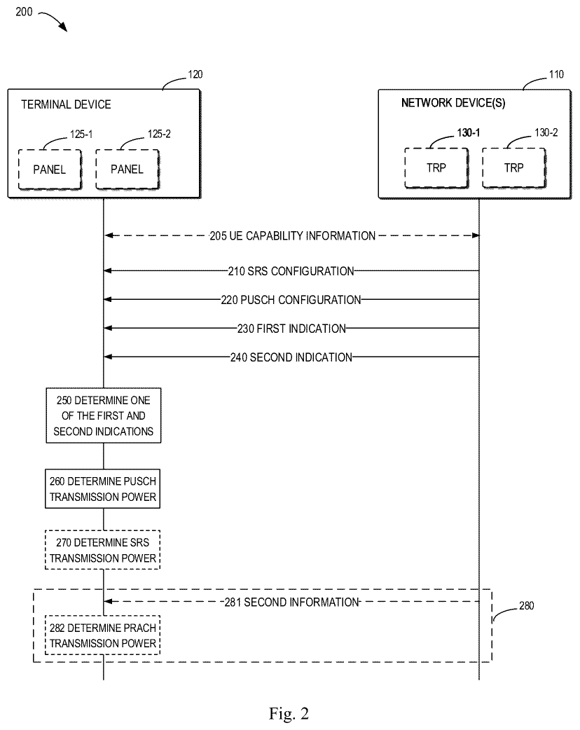

In view of this, embodiments of the present disclosure provide solutions of communication for UL PC so as to overcome the above or other potential issues. These solutions will be described below with reference to FIGS. 2 to 4. FIGS. 2 and 4 illustrate schematic diagrams illustrating processes of communication according to some example embodiments of the present disclosure. For the purpose of discussion, the processes will be described with reference to FIGS. 1A to 1C.

Each of the processes may involve the terminal device 120, the network device 110 (either or both of the first network device 110-1 and the second network device 110-2), and optionally may involve the TRPs 130 (including the first TRP 130-1 and the second TRP 130-2). In other words, the implementations of some embodiments do not depend on the TRPs 130. The terminal device 120 may be deployed with the first panel 125-1 and the second panel 125-2. Further, the first panel 125-1 corresponds to a first set of antenna ports and the second panel 125-2 corresponds to a second set of antenna ports.

Additionally, the first TRP 130-1 is connected to the first network device 110-1, while the second TRP 130-2 is connected to the first network device 110-1/second network device 110-2. In addition, the first TRP 130-1 and the second TRP may be in a same serving cell or in different serving cells.

In the following text, although some embodiments of the present disclosure are described with reference to two TRPs and two panels, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below.

Further, it is to be understood that the operations at the terminal device 120 and the network device 110 should be coordinated. In other words, the network device 110 and the terminal device 120 should have common understanding about configuration, parameter and so on. Such common understanding may be implemented by any suitable interactions between the network device 110 and the terminal device 120 or both the network device 110 and the terminal device 120 applying the same rule/policy. In the following, although some operations are described from a perspective of the terminal device 120, it is to be understood that the corresponding operations should be performed by the network device 110.

Similarly, although some operations are described from a perspective of the network device 110, it is to be understood that the corresponding operations should be performed by the terminal device 120. Merely for brevity, some of the same or similar contents are omitted here.

In addition, in the following description, some interactions are performed among the terminal device 120 and the network device 110 (such as, exchanging capability-related information, configuring/scheduling/activating resource/transmission and so on). It is to be understood that the interactions may be implemented either in one single signaling/message or multiple signaling/messages, including system information, a radio resource control (RRC) message, DCI, uplink control information (UCI), a medium access control (MAC) control element (CE) and so on. The present disclosure is not limited in this regard.

In some embodiments, the one or more interaction may be specific to a particular panel, a TRP, a capability value, a CORESET and so on. In this way, the PUSCH STxMP may be configured or activated flexibly.

Moreover, it should be understood that although feature(s)/operation(s) are discussed in specific example embodiments separately, unless clearly indicated to the contrary, these feature(s)/operation(s) described in different example embodiments may be used in any suitable combination.

### Example Implementation of UL PC within Unified TCI Framework

For illustration, some explanations are firstly made on a unified TCI framework and PL estimation as below.

A unified TCI for MTRP may comprise any of the following:
up to 4 indicated TCI states in a component carrier (CC)/bandwidth part (BWP) for MTRP operation
The indicated TCI states are updated by MAC-CE or DCI with the necessary MAC-CE based TCI state activation
UE can be configured/provided with one of the following combinations with 2 sets of indicated TCI states for DL and/or UL MTRP operations in a CC/BWP:
   1 indicated joint TCI state+1 indicated joint TCI state
   1 pair of indicated DL and UL TCI states+1 pair of indicated DL and UL TCI states
   1 pair of indicated DL and UL TCI states+1 indicated DL TCI state
   1 pair of indicated DL and UL TCI states+1 indicated UL TCI state
   1 indicated joint TCI state+1 pair of indicated DL and UL TCI states
   1 indicated joint TCI state+1 indicated DL TCI state
   1 indicated joint TCI state+1 indicated UL TCI state.

For PL estimation based on a PL RS, path loss may be determined based on equation (1) below.

$$P = P 1 - P 2 \qquad ( 1 )$$

where P denotes path loss for an active UL BWP b of carrier f based on the PL RS on the active DL BWP of serving cell c, P1 denotes reference signal power, and P2 denotes higher layer filtered RSRP. If UE is not configured with periodic CSI-RS reception, the reference signal power is provided by ss-PBCH-BlockPower. If UE is not configured with periodic CSI-RS reception, the reference signal power is provided either by ss-PBCH-BlockPower or by powerControlOffsetSS providing an offset of the CSI-RS transmission power relative to the SS/PBCH block transmission power. If powerControlOffsetSS is not provided to the UE, the UE assumes an offset of 0 dB.

FIG. 2 illustrates a schematic diagram illustrating a process 200 of communication for UL PC within a unified TCI framework according to some example embodiments of the present disclosure. For the purpose of discussion, the process 200 will be described with reference to FIGS. 1A to 1C.

With reference to FIG. 2, the terminal device 110 may transfer 205 information of UE capability with the network device 120. For example, the network device 120 may transmit, to the terminal device 110, a radio resource control (RRC) configuration regarding an UE capability reporting. The terminal device 110 may report capability of the terminal device 110 to the network device 120 based on the RRC configuration.

In some embodiments, the UE capability reporting may comprise at least one of the following: information about UE supports which signaling has a higher priority; information about whether UE supports a configuration of information of a TCI state to be used for PC; information about UE supports which default rule; or information about whether UE supports which default rule. It is to be understood that any other suitable capability reporting is also feasible.

### 1. UL PC for PUSCH Transmission

As shown in FIG. 2, the network device 110 transmits 210 a configuration (for convenience, also referred to as a SRS configuration or a first configuration herein) of SRS transmission to the terminal device 120. In some embodiments, the SRS configuration may comprise two SRS resource sets. For example, the two SRS resource sets may be configured with parameter “usage” set to “noncodebook” or “codebook”. It is to be understood that the number of the SRS resource sets is not limited to two, and any other suitable number is also feasible.

In some embodiments, the SRS configuration may comprise information (for convenience, also referred to as first information herein) of a TCI state to be used for PC. For example, each SRS resource set may be configured with one higher layer parameter “UseIndicatedTCIState” or any other suitable parameters having similar functions. The first information may be carried by the higher layer parameter “UseIndicatedTCIState” or any other suitable parameters having similar functions.

In some embodiments, the first information may comprise an identity (ID) of the TCI state. For example, the first information may comprise information about “Use the first TCI state” and “Use the second TCI state”, or in general, information about “use which TCI state” if more than one TCI states are active, for example, more than one TCI states are indicated via TCI fields in DCI.

In some embodiments, the first information may comprise an association between identities of SRS resource sets and identities of TCI states. In other words, the first information may be sorted by a mapping between a SRS resource set ID and a TCI state ID, e.g., the first SRS resource set ID is associated with the first TCI state ID explicitly or implicitly. Alternatively, more than one TCI states are active based on other configuration/activation signaling such as RRC or MAC CE, or based on predefined rules (i.e., not only limited to the case that TCI states are indicated via TCI fields in DCI).

In some embodiments, the first information may comprise an association between identities of SRS resource sets and identities of TRPs or CORESETs or CORESET groups or search space sets and an association between identities of TRPs or CORESETs or CORESET groups or search space sets and identities of TCI states. In other words, the first information may comprise a configuration of the association between SRS resource sets and TRPs, e.g., between SRS resource sets and CORESETs/CORESET groups/search space sets. If more than one TCI states are indicated, each of the TCI state should be associated with a different TRP, then the terminal device 120 may find “use which TCI state” for each of SRS resource sets.

In some embodiments, the first information may comprise a first value of a power control adjustment state, and the first value indicates the TCI state to be used for PC. In other words, the first information may comprise a configuration of a power control adjustment state (e.g., srs-PowerControlAdjustmentStates). The parameter “srs-PowerControlAdjustmentStates” may have different values for the two SRS resource sets, e.g., “sameAsFci1” and “sameAsFci2”, or “sameAsFci2” and not present. Alternatively, the parameter “srs-PowerControlAdjustmentStates” may take 0 and 1 respectively for the two SRS resource sets. For example, h_(b,f,c) (i,l)=f_(b,f,c) (i,l), where h_(b,f,c) (i,l) denotes SRS power control adjustment state, and f_(b,f,c) (i,l) denotes the current PUSCH power control adjustment state, where l may take 0 and 1 respectively for the two SRS resource sets.

In some embodiments, the first information (e.g., useIndicatedTCIState) may be configured for a DL/UL channel, including PDCCH/PDSCH/PUCCH/PUSCH. In some embodiments, the first information (e.g., useIndicatedTCIState) may be configured for a DL/UL reference signal, including CSI-RS/SRS. In some embodiments, the first information (e.g., useIndicatedTCIState) may be configured for a DL/UL cell/BWP/band. In some embodiments, the first information (e.g., useIndicatedTCIState) may contain more detailed information, such as using indicated TCI state(s) for determining QCL-Type A/B/C/D parameter, UL Tx beam, UL Tx power, PL RS, alpha, closedloopindex, P0, respectively.

Continue to refer to FIG. 2, the network device 110 may transmit 220, to the terminal device 120, a configuration (for convenience, also referred to as a second configuration herein) of PUSCH transmission. In some embodiments, the second configuration may comprise one or more PC configurations.

As shown in FIG. 2, the network device 110 may transmit 230 an indication (for convenience, also referred to as a first indication herein) indicating active TCI states. For example, the network device 110 may transmit DCI for beam indication change, and a TCI field in the DCI may indicate the active TCI states. It is to be understood that the first indication may be transmitted in any other suitable ways.

The network device 110 may also transmit 240 an indication (for convenience, also referred to as a second indication herein) indicating PC information. For example, the network device 110 may transmit DCI scheduling a PUSCH transmission, and a SRI field in the DCI may indicate PC configurations. It is to be understood that the second indication may be transmitted in any other suitable ways.

Accordingly, the terminal device 120 receives the first indication and the second indication. In this case, as shown in FIG. 2, the terminal device 120 may determine 250 one of the first and second indications for use in PC.

In some embodiments, the first indication (i.e., TCI state) may have a higher priority than that of the second indication (i.e., SRI). In some embodiments, the second indication (i.e., SRI) may have a higher priority than that of the first indication (i.e., TCI state). In this case, the terminal device 120 may determine the one of the first and second indications based on the priorities of the first and second indications.

In some embodiments, the network device 110 is responsible to guarantee the same configuration provided by the first and second indications. In some embodiments, the terminal device 120 does not expect that different PC configurations are provided by the first indication and the second indication. In some embodiments, the first indication and the second indication provide same power control information. For example, a PC parameter setting and a PL RS provided by TCI state and SRI in DCI points to a same parameters value such as a RS ID, estimate PL and eventually the same Tx power. In this case, the terminal device 120 may determine any of the first and second indications.

In some embodiments, the first configuration (i.e., SRS configuration) comprises the first information of the TCI state to be used for PC. In other words, the first information (e.g., UseIndicatedTCIState) must be configured for the SRS resource set(s). In this case, the terminal device 120 may calculate the same power based on the first indication and second indication. Alternatively, the terminal device 120 may use the first indication to calculate the power.

Continue to refer to FIG. 2, the terminal device 120 may determine 260 transmission power (for convenience, also referred to as first transmission power) of the PUSCH transmission based on the first and second configurations and the one of the first and second indications. In some embodiments, a timing relationship between two DCIs and application timing of PL RS may be considered.

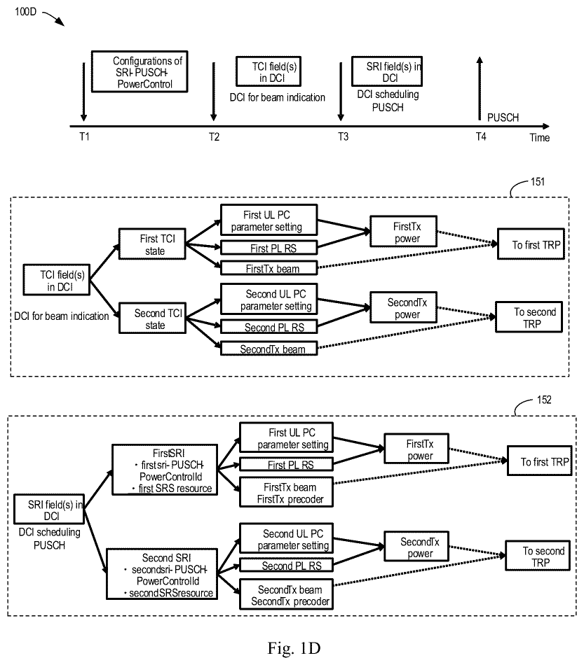

In some embodiments where the first indication (i.e., TCI state) has a higher priority than that of the second indication (i.e., SRI), the terminal device 120 may ignore PC information indicated by the second indication before an application timing of PC information indicated by the first indication. FIG. 3A illustrates an example scenario 300A of application timing according to some embodiments of the present disclosure.

In the example of FIG. 3A, at a timing t1, the terminal device 120 may receive DCI for beam indication, and the DCI comprises one or more TCI fields. At timing t2, the terminal device may receive DCI scheduling a PUSCH transmission at timing t3, and the DCI comprises one or more SRI fields. In this case, the terminal device 120 may ignore PC information indicated by the SRI received during t1+application timing, where t1 denotes a time point receiving the DCI of beam indication change or confirming reception of the DCI, and application timing denotes signaling decoding timing, panel switching timing, beam application timing, PL RS application timing, PUSCH preparation timing or any other suitable timings or any combination of the above timings or maximum of the above timings.

In some embodiments where the first indication (i.e., TCI state) has a higher priority than that of the second indication (i.e., SRI), the terminal device 120 may override PC information indicated by the second indication with PC information indicated by the first indication before an application timing of PC information indicated by the second indication. FIG. 3B illustrates another example scenario 300B of application timing according to some embodiments of the present disclosure.

In the example of FIG. 3B, at a timing t4, the terminal device may receive DCI scheduling a PUSCH transmission at timing t6, and the DCI comprises one or more SRI fields. At timing t5, the terminal device 120 may receive DCI for beam indication, and the DCI comprises one or more TCI fields. In this case, the terminal device 120 may override PC information indicated by the SRI with PC information indicated by the TCI state even before t4+application timing, i.e., ignore PC information indicated by the SRI during t4+application timing, where t4 denotes a time point receiving the DCI of beam indication change or confirming reception of the DCI, and application timing denotes signaling decoding timing, panel switching timing, beam application timing, PL RS application timing, PUSCH preparation timing or any other suitable timings or any combination of the above timings or maximum of the above timings.

In some embodiments where the second indication (i.e., SRI) has a higher priority than that of the first indication (i.e., TCI state), the terminal device 120 may ignore PC information indicated by the first indication before an application timing of PC information indicated by the second indication. FIG. 3C illustrates another example scenario 300C of application timing according to some embodiments of the present disclosure.

In the example of FIG. 3C, at a timing t7, the terminal device 120 may receive DCI for beam indication, and the DCI comprises one or more TCI fields. At timing t8, the terminal device may receive DCI scheduling a PUSCH transmission at timing t9, and the DCI comprises one or more SRI fields. In this case, the terminal device 120 may override PC information indicated by the TCI state with PC information indicated by the SRI even before t7+application timing, i.e., ignore PC information indicated by the TCI state during t10+application timing, where t7 denotes a time point receiving the DCI of beam indication change or confirming reception of the DCI, and application timing denotes signaling decoding timing, panel switching timing, beam application timing, PL RS application timing, PUSCH preparation timing or any other suitable timings or any combination of the above timings or maximum of the above timings.

In some embodiments where the second indication (i.e., SRI) has a higher priority than that of the first indication (i.e., TCI state), the terminal device 120 may override PC information indicated by the first indication with PC information indicated by the second indication before an application timing of PC information indicated by the first indication. FIG. 3D illustrates another example scenario 300D of application timing according to some embodiments of the present disclosure.

In the example of FIG. 3D, at a timing t10, the terminal device may receive DCI scheduling a PUSCH transmission at timing t12, and the DCI comprises one or more SRI fields. At timing t11, the terminal device 120 may receive DCI for beam indication change of beam, and the DCI comprises one or more TCI fields. In this case, the terminal device 120 may ignore PC information indicated by the TCI state during t10+application timing, where t10 denotes a time point receiving the DCI of beam indication change or confirming reception of the DCI, and application timing denotes signaling decoding timing, panel switching timing, beam application timing, PL RS application timing, PUSCH preparation timing or any other suitable timings or any combination of the above timings or maximum of the above timings.

It is to be understood that FIGS. 3A to 3D are merely examples, and do not make limitation for the present disclosure.

Based on the determined PC information (e.g., a PC parameter setting and a PL RS), the terminal device 120 may calculate the transmission power of the PUSCH transmission. In some embodiments, if the terminal device 120 transmits a PUSCH on active UL BWP b of carrier f of serving cell c using parameter set configuration with index j and PUSCH power control adjustment state with index 1, the terminal device 120 may determine PUSCH transmission power in PUSCH transmission occasion i as shown in equation (2) below.

$${P}_{PUSCH , b , f , c} ( i , j , {q}_{d} , l ) = min \{ \begin{matrix}{P}_{CMAX , f , c} ( i ) , \\ \begin{matrix}{P}_{O \_ PUSCH , b , f , c} ( j ) + 10 {log}_{10} ( {2}^{μ} \cdot {M}_{RB , b , f , c}^{PUSCH} ( i ) ) + \\ {α}_{b , f , c} ( j ) \cdot {PL}_{b , f , c} ( {q}_{d} ) + {Δ}_{TF , b , f , c} ( i ) + {f}_{b , f , c} ( i , l )\end{matrix}\end{matrix} \} \qquad ( 2 )$$

where P_{PUSCH, b, f, c}(i, j, q_{d}, l) denotes the PUSCH transmission power, P_{CMAX, f, c}(i) denotes configured maximum output power, P_{O_PUSCH, f, c}(0) denotes target power P0, a_{b, f, c}(j) denotes path loss exponent alpha,

$${M}_{R B , b , f , c}^{PUSCH} ( i )$$

denotes a bandwidth of PUSCH resource assignment expressed in number of resource blocks, PL_{b, f, c}(q_{d}) denotes a downlink path loss estimate in dB calculated by UE using reference signal (RS) index q_{d},

$${Δ}_{T F , b , f , c} ( i ) = 10 {log}_{10} ( ( {2}^{BPRE \cdot {K}_{s}} - 1 ) \cdot {β}_{offset}^{PUSCH} ) for {K}_{s} = 1.25 and {Δ}_{TF , b , f , c} ( i ) = 0 for {K}_{s} = 0$$

where Kₛ is provided by deltaMCS, and f_{b, f, c}(i, l) denotes a PUSCH power control adjustment state.

It is to be understood that the equation (2) is merely an example, and any other suitable ways are also feasible.

In this way, possible ambiguities of UL power determination may be eliminated.

### 2. UL PC for SRS Transmission

Continue to refer to FIG. 2, the terminal device 120 may also determine 270 transmission power (for convenience, also referred to as second transmission power herein) of a SRS transmission.

In some embodiments where the first information is configured or enabled, the terminal device 120 may determine a TCI state to be used for PC based on the first information and the first indication. That is, the terminal device 120 may select one of the active TCI states indicated by the first indication based on explicit or implicit information of a TCI state in the first information. Then the terminal device 120 may determine the transmission power of the SRS transmission based on PC information (e.g., PC parameter setting and PL RS) associated with the determined TCI state.

In some embodiments, the first information may be not configured or enabled. In this case, if a separate TCI state is configured for a SRS resource, transmission power may be determined based on the separate TCI state. If no separate TCI state is configured for the SRS resource, transmission power may be determined based on some default rules described later.

In some embodiments, if the terminal device 120 transmits a SRS on active UL BWP b of carrier f of serving cell c using SRS power control adjustment state with index 1, the terminal device 120 may determine SRS transmission power in SRS transmission occasion i as shown in equation (3) below.

$${P}_{SRS , b , f , c} ( i , {q}_{s} , l ) = min \{ \begin{matrix}{P}_{CMAX , f , c} ( i ) , \\ \begin{matrix}{P}_{O \_ SRS , b , f , c} ( {q}_{s} ) + 10 {log}_{10} ( {2}^{μ} \cdot {M}_{SRS , b , f , c} ( i ) ) + \\ {α}_{SRS , b , f , c} ( {q}_{s} ) \cdot {PL}_{b , f , c} ( {q}_{d} ) + {h}_{b , f , c} ( i , l )\end{matrix}\end{matrix} \} \qquad ( 3 )$$

where P_{SRS, b, f, c}(i, qₛ, l) denotes the SRS transmission power, P_{CMAX, f, c}(i) denotes configured maximum output power, P_{O_SRS, b, f, c}(qₛ) denotes target power P0, a_{SRS, b, f, c}(qₛ) denotes path loss exponent alpha, M_{SRS, b, f, c}(i) denotes a bandwidth of SRS resource assignment expressed in number of resource blocks, PL_{b, f, c}(q_{d}) denotes a downlink path loss estimate in dB calculated by UE using reference signal (RS) index q_{d}, and h_{b, f, c}(i, l)=f_{b, f, c}(i, l) where f_{b, f, c}(i, l) denotes a PUSCH power control adjustment state, if srs-PowerControlAdjustmentStates indicates a same power control adjustment state for SRS transmissions and PUSCH transmissions.

It is to be understood that the equation (3) is merely an example, and any other suitable ways are also feasible.

In this way, fast update on UL transmission power upon change of one or more UL beams may be enabled.

### 3. UL PC for PRACH Transmission

Continue to refer to FIG. 2, the terminal device 120 may also determine 280 transmission power (for convenience, also referred to as third transmission power herein) of a PRACH transmission. In some embodiments, a unified TCI state may be provided for reference signal power selection upon determination of PRACH transmission power. In some embodiments, if more than one TCI states are active for PDCCH carrying PDCCH order, the PDCCH order may provide reference signal power selection information.

In some embodiments, the terminal device 120 may receive 281, from the network device 110, information (for convenience, also referred to as second information herein) comprising at least one of a TCI state to be used for reference signal power determination or a TCI state to be used for a PL RS determination. Then the terminal device 120 may determine 282 transmission power (for convenience, also referred to as third transmission power herein) of a PRACH transmission based on the second information.

In some embodiments, if active TCI states for PDCCH that provides a PDCCH order are more than one, the terminal device 120 expects that the PDCCH order provides information on which TCI state is used for reference signal power determination, e.g., the terminal device 120 uses which RS when applying a value provided by powerControlOffsetSS. In other words, the terminal device 120 expects that the PDCCH order provides information about which TRP the PRACH is transmitted to, or about which RS is used as PL RS.

Such information may be indicated via an additional field in the PDCCH order. Or, such information may be implicitly indicated via exiting field(s) like Random Access Preamble index, SS/PBCH index, PRACH Mask index. Association between those indexes and TRP needs to be configured in advance. In some embodiments, the second information may comprise a configuration of the association between those indexes and TRPs, e.g., between those indexes and CORESETs/CORESET groups/search space sets. Alternatively, some default rules may be applied for the selection as described later.

In some embodiments, the terminal device 120 expects that an active TCI state for a PDCCH providing a PDCCH order is associated with a PL RS, and the associated PL RS is used for PL estimation including reference signal power selection and RSRP measurement. In some embodiments, the terminal device 120 expects that an active TCI state for a PDCCH providing a PDCCH order provides a QCL-TypeD RS that can be used for PL estimation. If the active TCI state is actually a pair of DL and UL TCI state, the terminal device 120 may apply a PL RS provided in the UL TCI state.

In some embodiments, if the TCI state to be used for reference signal power determination is associated with a cell (for convenience, also referred to as a first cell herein) different from a serving cell of the terminal device 120, the terminal device 120 may obtain the reference signal power (e.g., ss-PBCH-BlockPower) from the first cell.

In some embodiments, if the terminal device 120 transmits a PRACH on active UL BWP b of carrier f of serving cell c, the terminal device 120 may determine PRACH transmission power in PRACH transmission occasion i as shown in equation (4) below.

$${P}_{PRACH , b , f , c} ( i ) = min \{ {P}_{CMAX , f , c} ( i ) , {P}_{PRACH , target , f , c} + P {L}_{b , f , c} \} \qquad ( 4 )$$

where P_{PRACH, b, f, c}(i) denotes the PRACH transmission power, P_{CMAX, f, c}(i) denotes configured maximum output power, P_{PRACH, target, f, c} denotes target power P, and PL_{b, f, c} denotes a downlink path loss estimate in dB calculated by UE.

It is to be understood that the equation (4) is merely an example, and any other suitable ways are also feasible.

In this way, PRACH transmission power may be correctly calculated.

### 4. Default Rule for UL PC

In some scenarios, a power control parameter setting may be not provided by an applied TCI state. In this case, the terminal device 120 may use a default rule to determine a power control parameter setting.

In some embodiments, the terminal device 120 may determine the power control parameter setting based on a power control parameter setting associated with a TCI state comprising a power control configuration ID. In other words, the terminal device 120 may determine the power control parameter setting based on another TCI state. For example, the terminal device 120 may determine the power control parameter setting based on a TCI state applied to an associated CORESET. As another example, the terminal device 120 may determine the power control parameter setting based on a TCI state applied to a CORESET with a specific ID, e.g., the lowest ID or the lowest N ID. As a still another example, the terminal device 120 may determine the power control parameter setting based on a TCI state with a specific ID, e.g., the lowest ID or the lowest N ID.

In some embodiments, the terminal device 120 may determine the power control parameter setting based on a power control parameter setting having a predetermined ID. In other words, the terminal device 120 may determine the power control parameter setting based on another PC parameter setting. For example, the terminal device 120 may determine the power control parameter setting based on a PC parameter setting with a specific ID, e.g., 0 or 1. The ID may be sri-PUSCH-PowerControlld, Uplink-powerControlID, etc. As another example, the terminal device 120 may determine the power control parameter setting based on the latest applied PC parameter setting.

In some embodiments, the terminal device 120 may determine the power control parameter setting based on a power control parameter setting applied for a random access procedure within a period of time. For example, the terminal device 120 may determine the power control parameter setting based on a power control parameter setting latest applied for a random access procedure. It is to be understood that the terminal device 120 may also determine a power control parameter setting based on any suitable procedures other than the random access procedure.

It is also to be understood that any combination of the above and any other suitable rules may also be feasible.

In some scenarios, a PL RS may be not provided by an applied TCI state. In this case, the terminal device 120 may use a default rule to determine a PL RS.

In some embodiments, the terminal device 120 may determine a PL RS based on a TCI state comprising a configuration of a PL RS. In other words, the terminal device 120 may determine the PL RS based on another TCI state. For example, the terminal device 120 may determine the PL RS based on a TCI state applied to an associated CORESET. As another example, the terminal device 120 may determine the PL RS based on a TCI state applied to a CORESET with a specific ID, e.g., the lowest ID or the lowest N ID. As a still another example, the terminal device 120 may determine the PL RS based on a TCI state with a specific ID, e.g., the lowest ID or the lowest N ID.

In some embodiments, the terminal device 120 may determine a PL RS based on a predetermined PL RS. In other words, the terminal device 120 may determine the PL RS based on another PL RS. For example, the terminal device 120 may determine the PL RS based on a PL RS with a specific ID, e.g., 0 or 1. The ID may be sri-PUSCH-PowerControlId, Uplink-powerControlID, PUSCH-PathlossReferenceRS-Id, PUSCH-PathlossReferenceRS-Id, PUCCH-PathlossReferenceRS-Id, SRS-PathlossReferenceRS-Id, SRS resource ID, CSI-RS resource ID, SS/PBCH index, etc. As another example, the terminal device 120 may determine the PL RS based on the latest applied PL RS.

In some embodiments, the terminal device 120 may determine a PL RS based on a PL RS applied for a random access procedure within a period of time. For example, the terminal device 120 may determine the PL RS based on a PL RS latest applied for a random access procedure. It is to be understood that the terminal device 120 may also determine a PL RS based on any suitable procedures other than the random access procedure.

It is also to be understood that any combination of the above and any other suitable rules may also be feasible.

In some embodiments, the terminal device 120 may apply one or more default rules only within CORESET/TCI/RS set associated with a same TRP. In some embodiments, if the first TCI state is not associated with PC information, the terminal device 120 may apply one or more default rules to determine the first PC parameter setting and/or the first PL RS. In some embodiments, if the second TCI state is not associated with PC information, the terminal device 120 may apply one or more default rules to determine the second PC parameter setting and/or the second PL RS. In some embodiments, if both the first and second TCI states are not associated with PC information, the terminal device 120 may apply one or more default rules to determine the first and second PC parameter settings and/or the first and second PL RSs.

In this way, a terminal device may correctly find PC information even if the PC information is not provided by an applied TCI state.

### Example Implementation of UL PC for STxMP

For illustration, some explanations are firstly made on STxMP-MTRP schemes and UE power class as below.

STxMP-MTRP schemes may comprise any of the following:
SDM scheme: different layers/DMRS ports of one PUSCH are separately precoded and transmitted from different UE panels simultaneously.
FDM-B scheme: two PUSCH transmission occasions with same/different RV of the same TB are transmitted from different UE panels on non-overlapped frequency domain resources and the same time domain resources.
FDM-A scheme: different parts of the frequency domain resource of one PUSCH transmission occasion are transmitted from different UE panels.
SFN-based transmission scheme: all of the same layers/DMRS ports of one PUSCH are transmitted from two different UE panels simultaneously.
SDM repetition scheme: two PUSCH transmission occasions with same/different RV of the same TB are transmitted from two different UE panels simultaneously.

Table 1 below shows an example assumption of UE types.

TABLE 1

| UE Power Class | UE Type |
|---|---|
| 1 | Fixed wireless access (FWA) UE |
| 2 | Vehicular UE |
| 3 | Handheld UE |
| 4 | High power non-handheld UE |
| 5 | Fixed wireless access (FWA) UE |
| 6 | High speed train roof-mounted UE |
| 7 | RedCap UE |

Note:
RedCap variants of non-RedCap UEs are not precluded.

Table 2 below shows an example that UE maximum output power limits for UL MIMO for power class 1.

TABLE 2

| Operating band | Maximum TRP (dBm) | Maximum EIRP (dBm) |
|---|---|---|
| n257 | 35 | 55 |
| n258 | 35 | 55 |
| n260 | 35 | 55 |
| n261 | 35 | 55 |
| n262 | 35 | 55 |

UE may configure its maximum output power. The configured UE maximum output power P_{CMAX, f, c} for carrier f of a serving cell c is defined as that available to the reference point of a given transmitter branch that corresponds to the reference point of the higher-layer filtered RSRP measurement as specified in TS 38.215.

For per panel power limitation, each panel may perform a transmission with maximum power, and may be used simultaneously. For cross panel power limitation (may also referred to as per UE power limitation), maximum power may be achieved when panels are used simultaneously. For cross panel power limitation with power sharing, maximum power may be achieved for one panel. For cross panel power limitation without power sharing, when one panel is used, maximum power may be not achieved for the one panel.

In some assumptions, total power limitation per UE over all UE panels used for STxMP or a sum of per-panel power limitation for STxMP may be different from (e.g., greater than) the existing power limitation for a given power class. In some assumptions, total power limitation per UE over all UE panels used for STxMP or a sum of per-panel power limitation for STxMP may not be different from (e.g., not greater than) the existing power limitation for a given power class. In some assumptions, a sum of per-panel power limitation may be larger than total power limitation per UE. In some assumptions, a sum of per-panel power limitation may not be larger than total power limitation per UE.

FIG. 4 illustrates a schematic diagram illustrating a process 400 of communication for UL PC for STxMP according to some example embodiments of the present disclosure. For the purpose of discussion, the process 400 will be described with reference to FIGS. 1A to 1C. In this example, the terminal device 120 is deployed with two panels 125-1 and 125-2. It is to be understood that the process 400 may also be applied for more panels.

With reference to FIG. 4, the terminal device 110 may transfer 405 information of UE capability with the network device 120. For example, the network device 120 may transmit, to the terminal device 110, a radio resource control (RRC) configuration regarding an UE capability reporting. The terminal device 110 may report capability of the terminal device 110 to the network device 120 based on the RRC configuration.

In some embodiments, the UE capability reporting may comprise at least one of the following: information about whether UE supports one or several power assumptions; information about whether UE supports calculation of PUSCH/PUCCH/SRS/PRACH Tx power information per panel; information about whether UE supports calculation of PHR per panel; information about whether UE supports calculation of PUSCH-DMRS power ratio per panel; information about whether UE supports calculation of PUSCH-PTRS power ratio per panel; the number of Pcmax supported by UE; or the number of PHRs supported by UE. It is to be understood that any other suitable capability reporting is also feasible.

### 1. UL Transmission Power Calculation

As shown in FIG. 4, the network device 110 may transmit 410 an indication of STxMP to the terminal device 120. In some embodiments, the indication of STxMP may comprise an indication of a STxMP-MTRP scheme such as a SDM scheme, FDM-B scheme, FDM-A scheme, a SFN-based transmission scheme, or a SDM repetition scheme. In some embodiments, the indication of STxMP may comprise a switching between a non-STxMP mode and a STxMP mode. It is to be understood that the indication of STxMP may also comprise any other suitable information.

In response to the indication, the terminal device 120 may perform an UL transmission (e.g., PUSCH or any other suitable UL transmissions) over the panels 125-1 and 125-2 simultaneously. The terminal device 120 may determine 420 transmission power of the uplink transmission based on at least one power limitation for panels.

### Per Panel Power Limitation

In some embodiments where per panel power limitation is used, the power limitation may comprise first threshold power (e.g., first Pcmax) for the panel 125-1 and second threshold power (e.g., second Pcmax) for the panel 125-2.

In some embodiments, the first threshold power and the second threshold power may be based on information provided via UE capability reporting or PHR reporting.

In some embodiments, the first Pcmax and the second Pcmax may be the same. For example, the terminal device 120 may determine Pcmax based on UE power class and determine that first Pcmax=second Pcmax=Pcmax. As total power when STxMP is enabled may exceed upper limit, UE power class may need to be re-defined. In some alternative embodiments, the terminal device 120 may determine that first Pcmax=second Pcmax=Pcmax/2.

In some embodiments, the first Pcmax and the second Pcmax may be different, and (first Pcmax+second Pcmax)≤Pcmax. It is to be understood that two panels may be extended to N panels, where N is greater than 2.

In some embodiments, the terminal device 120 may determine transmission power for the panel 125-1 based on the first Pcmax, and determine transmission power for the panel 125-2 based on the second Pcmax. For example, the terminal device 120 may determine the transmission power for the panel 125-1 and the transmission power for the panel 125-2 respectively based on the equation (2) described above. Parameters in the equation (2) are associated with the same panel.

Then the terminal device 120 may determine transmission power (i.e., the first transmission power) for the UL transmission based on the transmission power for the panel 125-1 and the transmission power for the panel 125-2. For example, the transmission power for the UL transmission may be equal to a sum of the transmission power for the panel 125-1 and the transmission power for the panel 125-2.

Cross Panel Power Limitation without Power Sharing Across Panels

In some embodiments where cross panel power limitation is used, the power limitation may comprise threshold power (e.g., Pcmax). In some embodiments, the threshold power may be based on currently defined UE power class.

In some embodiments, the terminal device 120 may determine scaled threshold power based on the threshold power divided by the number of panels. For example, the terminal device 120 may scale Pcmax with 1/N for each panel, where N denotes the number of panels used for simultaneous transmission. Alternatively, N may be a total number of panels of UE. In some embodiments, N may be based on information provided via UE capability reporting or PHR reporting.

Then the terminal device 120 may determine, based on the scaled threshold power, transmission power for the panel 125-1 and determine, based on the scaled threshold power, transmission power for the panel 125-2. For example, the terminal device 120 may determine the transmission power for the panel 125-1 and the transmission power for the panel 125-2 respectively based on the equation (2) described above. Parameters in the equation (2) are associated with the same panel.

Accordingly, the terminal device 120 may determine transmission power (i.e., the first transmission power) for the UL transmission based on the transmission power for the panel 125-1 and the transmission power for the panel 125-2. For example, the transmission power for the UL transmission may be equal to a sum of the transmission power for the panel 125-1 and the transmission power for the panel 125-2.

Cross Panel Power Limitation with Power Sharing Across Panels

In some embodiments where cross panel power limitation is used, the power limitation may comprise threshold power (e.g., Pcmax). In some embodiments, the threshold power may be based on currently defined UE power class.

In some embodiments, the terminal device 120 may determine transmission power for the panel 125-1 based on the threshold power, and determine transmission power for the panel 125-2 based on the threshold power. For example, the terminal device 120 may determine the transmission power for the panel 125-1 base on equation (5) below.

$${P}_{Panel 1} = {P}_{O , panel 1} + 10 log 10 ( {2}^{{μ}_{panel 1}} \cdot {M}_{R B}^{panel 1} ) + {α}_{p a nel 1} \cdot {PL}_{panel 1} ( {q}_{d} ) + adjustment\_panel1 \qquad ( 5 )$$

where P_{Pane1} denotes transmission power for panel 1, P_{0,panel1} denotes target power P0 for panel 1,

$${M}_{RB}^{panel 1}$$

denotes a bandwidth of resource assignment for panel 1 expressed in number of resource blocks, αₚₐₙₑₗ₁ denotes path loss exponent alpha for panel 1, PLₚₐₙₑₗ₁ (q_{d}) denotes a downlink path loss estimate for panel 1 in dB calculated by UE using reference signal (RS) index q_{d}, and adjustment_panel1 denotes a PUSCH power control adjustment state for panel 1. In addition, q_{d} may be q_{d,panel1}, i.e., panel-specific PL RS.

For example, the terminal device 120 may determine the transmission power for the panel 125-2 base on equation (6) below.

$${P}_{Panel 2} = {P}_{O , panel 2} + 10 log 10 ( {2}^{{μ}_{panel 2}} \cdot {M}_{R B}^{panel 2} ) + {α}_{p anel 2} \cdot {PL}_{panel 2} ( {q}_{d} ) + adjustment\_panel2 \qquad ( 6 )$$

where P_{Panel2} denotes transmission power for panel 2, P_{0,panel2} denotes target power P0 for panel 2,

$${M}_{RB}^{panel 2}$$

denotes a bandwidth of resource assignment for panel 2 expressed in number of resource blocks, αₚₐₙₑₗ₂ denotes path loss exponent alpha for panel 2, PLₚₐₙₑₗ₂ (q_{d}) denotes a downlink path loss estimate for panel 2 in dB calculated by UE using reference signal (RS) index q_{d}, and adjustment_panel2 denotes a PUSCH power control adjustment state for panel 2. In addition, q_{d} may be q_{d,panel2}, i.e., panel-specific PL RS.

The terminal device 120 may determine whether a sum of the transmission power for the panel 125-1 and the transmission power for the panel 125-2 is larger than the threshold power (i.e., Pcmax). If the sum is below the threshold power, the the terminal device 120 may determine the transmission power of the UL transmission based on the transmission power for the panel 125-1 and the transmission power for the panel 125-2.

If the sum is larger than the threshold power, the terminal device 120 may determine scaled transmission power for the panel 125-1 based on the transmission power for the panel 125-1 and a ratio of the threshold power to the sum. For example, the terminal device 120 may determine scaled transmission power for the panel 125-1 based on equation (7) below.

$${P}_{P a nel 1}^{′} = {P}_{Panel 1} \frac{{P}_{c M A X}}{{P}_{Panel 1} + {P}_{Panel 2}} \qquad ( 7 )$$

where P_{Panel1}′ denotes scaled transmission power for panel 1, P_{Panel1} denotes transmission power for panel 1, and

$$\frac{{P}_{c M A X}}{{P}_{Panel 1} + {P}_{Panel 2}}$$

denotes the ratio of the threshold power to the sum.

Similarly, the terminal device 120 may determine scaled transmission power for the panel 125-2 based on the transmission power for the panel 125-2 and a ratio of the threshold power to the sum. For example, the terminal device 120 may determine scaled transmission power for the panel 125-2 based on equation (8) below.

$${P}_{P anel 2}^{′} = {P}_{Panel 2} \frac{{P}_{c M A X}}{{P}_{Panel 1} + {P}_{Panel 2}} \qquad ( 8 )$$

where P_{Panel2}′ denotes scaled transmission power for panel 2, P_{Panel2} denotes transmission power for panel 2, and

$$\frac{{P}_{c M A X}}{{P}_{Panel 1} + {P}_{Panel 2}}$$

denotes the ratio of the threshold power to the sum.

Then the terminal device 120 may determine the transmission power of the UL transmission based on the scaled transmission power for the panel 125-1 and the scaled transmission power for the panel 125-2. For example, the transmission power for the UL transmission may be equal to a sum of the scaled transmission power for the panel 125-1 and the scaled transmission power for the panel 125-2.

In this way, UL power may be correctly calculated without violating restriction on maximum radiated power.

### 2. UL DMRS Power Calculation

Continue to refer to FIG. 4, the terminal device 120 may determine 430 transmission power (for convenience, also referred to as second transmission power herein) for a RS transmission based on the at least one power limitation, the transmission power of the UL transmission and a ratio of a power related parameter between the UL transmission and the RS transmission. According to embodiments of the present disclosure, the ratio of the power related parameter between the UL transmission and the RS transmission is determined based on the at least one power limitation.

In some embodiments, the RS transmission may be a demodulation reference signal (DMRS) transmission, and the ratio of the power related parameter may be a PUSCH-to-DMRS power ratio. In some embodiments, the PUSCH-to-DMRS power ratio may be a PUSCH-to-DMRS energy per resource element (EPRE) ratio. It is to be understood that the PUSCH-to-DMRS power ratio may also adopt any other suitable forms.

In some embodiments where cross panel power limitation is used, a PUSCH-to-DMRS EPRE ratio may be based on the number of DMRS CDM groups without data if the terminal device 120 supports power sharing across panels.

In some embodiments where per panel power limitation is used, a PUSCH-to-DMRS power ratio may be determined based on the number of DMRS code division multiplexing (CDM) groups without data per panel. More detailed description will be given in connection with Embodiments 1 to 3.

### Embodiment 1

In this embodiment, per panel power boosting may be done by using “PUSCH-DMRS power ratio per panel” or “PUSCH-DMRS power ratio per layer” or “PUSCH-DMRS power ratio per panel per layer” or “PUSCH-DMRS EPRE ratio per panel” or “PUSCH-DMRS EPRE ratio per layer” or “PUSCH-DMRS EPRE ratio per panel per layer” or “PUSCH-DMRS EPRE ratio per layer per panel”, instead of “PUSCH-DMRS EPRE ratio”.

In some embodiments, the terminal device 120 may determine a first PUSCH-to-DMRS power ratio for the panel 125-1 based on the number of DMRS CDM groups without data associated with the panel 125-1. In some embodiments, the terminal device 120 may determine the first PUSCH-to-DMRS power ratio by looking up a table comprising a mapping between a PUSCH-to-DMRS power ratio for a panel and the number of DMRS CDM groups without data associated with the panel. In some embodiments, the terminal device 120 may calculate a value (denoted as R) based on equation (8′) below and determine the first PUSCH-to-DMRS power ratio by rounding up or down the R value or taking a predetermined number of decimals for the R value. The predetermined number may be any suitable positive integers.

$$R = 10 log 10 ( X ) \qquad ( 8 ’ )$$

where R denotes an intermediate value for calculating PUSCH-to-DMRS power ratio, and X denotes the number of DMRS CDM groups without data associated with the panel.

Then the terminal device 120 may determine transmission power for a first DMRS transmission via the panel 125-1 based on transmission power for a first UL transmission via the panel 125-1 and the first PUSCH-to-DMRS power ratio.

Similarly, the terminal device 120 may determine a second PUSCH-to-DMRS power ratio for the panel 125-2 based on the number of DMRS CDM groups without data associated with the panel 125-2. In some embodiments, the terminal device 120 may determine the second PUSCH-to-DMRS power ratio by looking up a table comprising a mapping between a PUSCH-to-DMRS power ratio for a panel and the number of DMRS CDM groups without data associated with the panel. In some embodiments, the terminal device 120 may calculate R value based on the equation (8′) and determine the second PUSCH-to-DMRS power ratio by rounding up or down the R value or taking a predetermined number of decimals for the R value. The predetermined number may be any suitable positive integers.

Then the terminal device 120 may determine transmission power for a second DMRS transmission via the panel 125-2 based on transmission power for a second UL transmission via the panel 125-2 and the second PUSCH-to-DMRS power ratio.

Table 3 below shows example values of “antenna ports” field.

TABLE 3

| | Number of DMRS CDM | |
|---|---|---|
| Value | group(s) without data | DMRS port(s) |
| 0 | 1 | 0 |
| 1 | 1 | 1 |
| 2 | 2 | 0 |
| 3 | 2 | 1 |
| 4 | 2 | 2 |
| 5 | 2 | 3 |
| 6-7 | Reserved | Reserved |

Table 4 below shows an example PUSCH-DMRS EPRE ratio.

TABLE 4

| Number of | | | | |
|---|---|---|---|---|
| DM-RS CDM | DM-RS configuration | | DM-RS configuration | |
| groups without data | type 1 | | type 2 | |
| 1 | 0 | dB | 0 | dB |
| 2 | −3 | dB | −3 | dB |

| | | | |
|---|---|---|---|
| 3 | — | −4.77 | dB |

Table 5 below shows an example relationship among ports, CDM groups and panels.

TABLE 5

| Port number | CDM group | Panel ID |
|---|---|---|
| 0 | 0 | First panel |
| 1 | 0 | First panel |
| 2 | 1 | Second panel |
| 3 | 1 | Second panel |

It is to be understood that Tables 3 to 5 are merely examples, and any other suitable ways are also feasible.

For example, the number of DMRS CDM groups without data may be provided in “antenna ports” field in DCI (e.g., format 0_1 or 0_2). The number of DMRS CDM groups without data may be “1”, “2”, “3” which may correspond to CDM group 0, {0,1}, {0, 1, 2}, respectively.

If a value of the “antenna ports” field is “2”, it may be known from Table 3 that the number of DMRS CDM groups without data is “2”, and a DMRS port is 0. It also may be known from Table 4 that DMRS may be transmitted at port 0 with 3 dB higher than an UL transmission. As the number of DMRS CDM groups without data is “2”, the CDM group is {0,1}. It may be known from Table 5 that port 0 and port 1 are associated with one panel (e.g., the panel 125-1) and port 2 and port 3 are associated with another panel (e.g., the panel 125-2).

For the panel 125-1, DMRS may be transmitted at port 0 with 3 dB higher than an UL transmission. However, since port 2 and port 3 are associated with another panel, the power may not be used for DMRS power boosting, i.e., 0 dB is assumed. Sum of power for the two panels does not change for DMRS and PUSCH, EPRE ratio is now 0 dB. But for per panel DMRS-PUSCH power ratio, DMRS may be transmitted with 3 dB higher than PUSCH.

Upon determination of the transmission power for the first DMRS transmission and the transmission power for the second DMRS transmission, the second transmission power may be determined. For example, the second transmission power may be a sum of the transmission power for the first DMRS transmission and the transmission power for the second DMRS transmission.

### Embodiment 2

In this embodiment, a terminal device may keep using “PUSCH-DMRS EPRE ratio”, and also consider whether DMRS port(s) and port(s) in the DMRS CDM groups without data are associated with the same panel to count “the number of DMRS CDM groups without data”.

In some embodiments, the terminal device 120 may determine whether a set of antenna ports in DMRS CDM groups without data and a set of antenna ports for DMRS transmission are associated with the same panel. If the set of antenna ports in DMRS CDM groups without data and the set of antenna ports for DMRS transmission are associated with different panels, the terminal device 120 may determine an updated number of DMRS CDM groups without data.

In some embodiments, the updated number of DMRS CDM groups without data may be determined by equation (9) below.

$$Nu = N - X \qquad ( 9 )$$

where Nu denotes the updated number of DMRS CDM groups without data, N denotes the indicated number of DMRS CDM groups without data, and X denotes the number of DMRS CDM groups on a different panel from the indicated DMRS port.

In some embodiments, the updated number of DMRS CDM groups without data may be determined by equation (10) below.

$$Nu = Y , where Y \leq N \qquad ( 10 )$$

where Nu denotes the updated number of DMRS CDM groups without data, N denotes the indicated number of DMRS CDM groups without data, and Y denotes the number of DMRS CDM groups on the same panel as an indicated DMRS port. The indicated DMRS port may be a configured DMRS port, a determined DMRS port or a target DMRS port.

It is to be understood that equations (9) and (10) are merely examples, and any other suitable ways are also feasible. The present disclosure does not limit this aspect.

Then the terminal device 120 may determine a PUSCH-to-DMRS power ratio based on the updated number of DMRS CDM groups without data. In some embodiments, the terminal device 120 may determine the PUSCH-to-DMRS power ratio by looking up a table. In some embodiments, the terminal device 120 may calculate an R value based on equation (8′) and determine the PUSCH-to-DMRS power ratio by rounding up or down the R value or taking a predetermined number of decimals for the R value.

Then the terminal device 120 may determine the transmission power of DMRS transmission based on the transmission power of UL transmission and the PUSCH-to-DMRS power ratio.

For example, if a value of the “antenna ports” field is “2”, it may be known from Table 3 that the number of DMRS CDM groups without data is “2”, and a DMRS port is 0. As the number of DMRS CDM groups without data is “2”, the CDM group is {0,1}. It may be known from Table 5 that a set of antenna ports in DMRS CDM groups without data comprise ports 0, 1, 2 and 3 which are associated with a different panel from DMRS port 0. As ports in CDM group 0 is on the same panel as DMRS port 0 and ports in CDM group 1 is on a different panel from DMRS port 0, an updated number of DMRS CDM groups without data may be determined as 1 based on equation (9) or (10). Thus, it may be known from Table 4 that DMRS may be transmitted at port 0 with OdB higher than an UL transmission, i.e., the power may not be used for DMRS power boosting.

### Embodiment 3

In this embodiment, the number of DMRS CDM groups without data may be set to “1” regardless of DMRS port number, i.e., no power boost is allowed.

In some embodiments, if per panel power limitation is assumed, or if cross panel power limitation is assumed and no power sharing is allowed, it is impossible to borrow power from another panel even it is not used for data transmission.

In some embodiments, if cross panel power limitation is assumed and power sharing among panels is allowed, a legacy boosting ratio may be assumed.

In this way, DMRS may be correctly boosted for PUSCH demodulation.

### 3. UL PTRS Power Calculation

In some embodiments, the RS transmission may be a phase tracking reference signal (PTRS) transmission, and the ratio of the power related parameter may be a PUSCH-to-PTRS power ratio. In some embodiments, the PUSCH-to-PTRS power ratio may be a PUSCH-to-PTRS power ratio per layer. It is to be understood that the PUSCH-to-PTRS power ratio may also adopt any other suitable forms.

A PUSCH-to-PTRS power ratio per layer is related to the number of PUSCH layers, antenna port, coherence type and configurations, and is used to boost PTRS power when corresponding resource elements are not used for data transmission.

In some embodiments where per panel power limitation is used or cross panel power limitation is used but no power sharing among panels, two PTRSs may be needed and one PTRS is used for one panel. A PUSCH-to-DMRS power ratio per layer may be determined based on the number of PUSCH layers assigned to one panel.

In some embodiments, the terminal device 120 may determine the number of PUSCH layers (for convenience, also referred to as a first number of PUSCH layers herein) assigned to the panel 125-1, and determine a first PUSCH-to-PTRS power ratio per layer for the panel 125-1 based on the first number of PUSCH layers.

In some embodiments, the terminal device 120 may determine the first PUSCH-to-PTRS power ratio per layer by looking up a table comprising a mapping between a PUSCH-to-PTRS power ratio per layer for a panel and the number of PUSCH layers associated with the panel.

In some embodiments, the terminal device 120 may calculate a value (denoted as R′) based on equation (10′) below and determine the first PUSCH-to-PTRS power ratio per layer by rounding up or down the R′ value or taking a predetermined number of decimals for the R′ value. The predetermined number may be any suitable positive integers.

$$R ’ = 10 log 10 ( X ’ ) \qquad ( 10 ’ )$$

where R′ denotes an intermediate value for calculating a PUSCH-to-PTRS power ratio per layer, and X′ denotes the number of PUSCH layers associated with the panel.

Then the terminal device 120 may determine transmission power of a first PTRS transmission via the panel 125-1 based on the first PUSCH-to-PTRS power ratio per layer and the transmission power of UL transmission.

Table 6 below shows an example factor related to PUSCH to PTRS power ratio per layer per RE.

TABLE 6

| | | The number of PUSCH layers | | | | | | |
|---|---|---|---|---|---|---|---|---|
| | | 2 | | 3 | | | | |
| PUSCH- | | | Partial | | Partial | 4 | | |
| to-PTRS | | | and non- | | and non- | | | non- |
| power | | | coherent | | coherent | | | coherent |
| ratio per | 1 | | and non- | | and non- | | | and non- |
| layer per | All | Full | codebook | Full | codebook | Full | Partial | codebook |
| RE | cases | coherent | based | coherent | based | coherent | coherent | based |
| 00 | 0 | 3 | 3Qₚ-3 | 4.77 | 3Qₚ-3 | 6 | 3Qₚ | 3Qₚ-3 |
| 01 | 0 | 3 | 3 | 4.77 | 4.77 | 6 | 6 | 6 |

| | |
|---|---|
| 10 | Reserved |
| 11 | Reserved |

For example, in STxMP SDM transmission (of course, it is not limited to this mode), layer 1, 2 is from panel 1 and layer 3, 4 is from panel 2. Upon determining a PUSCH-to-PTRS power ratio, the number of PUSCH layers is 2, instead of 4. It can be seen from Table 6 that the ratio should be 3 dB instead of 6 dB. It is to be understood that this is merely an example, and the present disclosure is not limited to this.

Similarly, the terminal device 120 may determine the number of PUSCH layers (for convenience, also referred to as a second number of PUSCH layers herein) assigned to the panel 125-2, and determine a second PUSCH-to-PTRS power ratio per layer for the panel 125-2 based on the second number of PUSCH layers. In some embodiments, the terminal device 120 may determine the second PUSCH-to-PTRS power ratio per layer by looking up a table comprising a mapping between a PUSCH-to-PTRS power ratio per layer for a panel and the number of PUSCH layers associated with the panel. In some embodiments, the terminal device 120 may calculate a value (denoted as R′) based on the equation (10′) and determine the second PUSCH-to-PTRS power ratio per layer by rounding up or down the R′ value or taking a predetermined number of decimals for the R′ value. The predetermined number may be any suitable positive integers.

Then the terminal device 120 may determine transmission power of a second PTRS transmission via the panel 125-2 based on the second PUSCH-to-PTRS power ratio per layer and the transmission power of UL transmission.

Based on the transmission power for the first PTRS transmission and the transmission power for the second PTRS transmission, the transmission power of PTRS transmission may be determined.

In some embodiments where cross panel power limitation is used and power sharing is allowed among panels for simultaneous transmission, one PTRS may be enough, and a PUSCH-to-PTRS power ratio per layer may be determined based on the total number of PUSCH layers.

In some embodiments, a PUSCH-to-PTRS power ratio per layer per RE per panel may be used instead of a PUSCH-to-PTRS power ratio per layer per RE. In some embodiments, the terminal device 120 may determine the number of PUSCH layers, and determine a PUSCH-to-PTRS power ratio per layer per resource element per panel based on the number of PUSCH layers. Then the terminal device 120 may determine the transmission power of PTRS transmission based on the PUSCH-to-PTRS power ratio per layer per RE per panel and the transmission power of UL transmission.

In this way, PTRS transmission power may be correctly determined.

Return to FIG. 4, upon determination of transmission power of UL transmission and transmission power of RS transmission, the terminal device 120 may perform 440 the UL transmission and RS transmission accordingly.

### 4. PHR Calculation and Report

Continue to refer to FIG. 4, the terminal device 120 may determine 450 power headroom (PH) for the UL transmission considering power consumption of panels for simultaneous transmission. Then the terminal device 120 may transmit 460 a power headroom report (PHR) to the network device 110. For illustration, some example embodiments will be described with reference to Embodiments 4 to 6.

### Embodiment 4

In this embodiment, a PHR may be determined based on an actual transmission.

### Per Panel Power Limitation

In some embodiments where per panel power limitation is used, two threshold power and two PHs may be provided for calculation of two PHs. In some embodiments, the power limitation comprises first threshold power for the panel 125-1 and second threshold power for the panel 125-2.

In some embodiments, the terminal device 120 may determine first PH for the panel 125-1 based on the first threshold power and transmission power of a first UL transmission via the panel 125-1. For example, the first PH may be determined by equation (11) below.

$$PH 1 = {P}_{cMAX , Panel 1} - {P}_{Panel 1} \qquad ( 11 )$$

where PH1 denotes a PH for panel 1, P_{cMAX, Panel1} denotes threshold power for panel 1, and P_{Panel1} denotes transmission power of UL transmission of panel 1.

Similarly, the terminal device 120 may determine second PH for the panel 125-2 based on the second threshold power and transmission power of a second UL transmission via the panel 125-2. For example, the second PH may be determined by equation (12) below.

$$PH 2 = {P}_{cMAX , Panel 2} - {P}_{Panel 2} \qquad ( 12 )$$

where PH2 denotes a PH for panel 2, P_{cMAX, Panel2} denotes threshold power for panel 2, and P_{Panel2} denotes transmission power of UL transmission of panel 2.

Then the terminal device 120 may report the first PH and the second PH. It is to be understood that equations (11) and (12) are merely examples, and any other suitable forms are also feasible.

### Cross Panel Power Limitation

In some embodiments where cross panel power limitation is used, one threshold power and one or two PHs may be provided for calculation of one or two PHs for STxMP. In some embodiments, the power limitation comprises threshold power for the panels 125-1 and 125-2.

In some embodiments where power sharing is not allowed, the terminal device 120 may determine scaled threshold power based on the number of panels and threshold power. The terminal device 120 may determine first PH for the panel 125-1 based on the scaled threshold power and transmission power of a first UL transmission via the panel 125-1. For example, the first PH may be determined by equation (13) below.

$$PH 1 = \frac{1}{2} {P}_{cMAX} - {P}_{Panel 1} \qquad ( 13 )$$

where PH1 denotes a PH for panel 1, P_{cMAX} denotes configured threshold power, and P_{Panel1} denotes transmission power of UL transmission of panel 1.

Similarly, the terminal device 120 may determine second PH for the panel 125-2 based on the scaled threshold power and transmission power of a second UL transmission via the panel 125-2. For example, the second PH may be determined by equation (14) below.

$$PH 2 = \frac{1}{2} {P}_{cMAX} - {P}_{Panel 2} \qquad ( 14 )$$

where PH2 denotes a PH for panel 2, P_{cMAX} denotes configured threshold power, and P_{Panel2} denotes transmission power of UL transmission of panel 2.

Then the terminal device 120 may report the first PH and the second PH. It is to be understood that equations (13) and (14) are merely examples, and any other suitable forms are also feasible.

In some embodiments where power sharing is allowed, a sum of Tx RS from two panels may need to be deduced. In some embodiments, the terminal device 120 may determine PH for the UL transmission based on the threshold power and a sum of transmission power of a first UL transmission via the panel 125-1 and transmission power of a second UL transmission via the panel 125-2. For example, the PH may be determined by equation (15) below.

$$PH = {P}_{cMAX} - ( {P}_{Panel 1} + {P}_{Panel 2} ) \qquad ( 15 )$$

where PH denotes a PH for UL transmission, P_{cMAX} denotes configured threshold power, P_{Panel1} denotes transmission power of UL transmission of panel 1, and P_{Panel2} denotes transmission power of UL transmission of panel 2.

Then the terminal device 120 may report the PH. It is to be understood that equation (15) is merely an example, and any other suitable forms are also feasible.

### Embodiment 5

In this embodiment, a PHR may be determined based on a reference transmission. Assumed Pcmax is denoted with \tilde{P}_{cMAX}, and the power consumption is based on reference transmissions with some assumed values. For example, transmission power for panel 1 may be calculated based on equation (16) below.

$${\tilde{P}}_{Panel 1} = {P}_{O , panel 1} + {α}_{panel 1} \cdot {PL}_{panel 1} ( {q}_{d} ) + adjustment\_panel1 \qquad ( 16 )$$

where \tilde{P}_{Panel1} denotes transmission power for panel 1 based on reference transmission, P_{O,panel1} denotes target power P0 for panel 1, αₚₐₙₑₗ₁ denotes path loss exponent alpha for panel 1, PLₚₐₙₑₗ₁ (q_{d}) denotes a downlink path loss estimate for panel 1 in dB calculated by UE using reference signal (RS) index q_{d}, and adjustment_panel1 denotes a PUSCH power control adjustment state for panel 1. In addition, q_{d} may be q_{d,panel1}, i.e., panel-specific PL RS.

Transmission power for panel 2 may be calculated based on equation (17) below.

$${\tilde{P}}_{Panel 2} = {P}_{O , panel 2} + {α}_{panel 2} \cdot {PL}_{panel 2} ( {q}_{d} ) + adjustment\_panel2 \qquad ( 17 )$$

where \tilde{P}_{Panel2} denotes transmission power for panel 2 based on reference transmission, P_{O, panel2} denotes target power P0 for panel 2, αₚₐₙₑₗ₂ denotes path loss exponent alpha for panel 2, PLₚₐₙₑₗ₂ (q_{d}) denotes a downlink path loss estimate for panel 2 in dB calculated by UE using reference signal (RS) index q_{d}, and adjustment_panel2 denotes a PUSCH power control adjustment state for panel 2. In addition, q_{d} may be q_{d,panel2}, i.e., panel-specific PL RS.

### Per Panel Power Limitation

In some embodiments where per panel power limitation is used, two threshold power and two PHs may be provided for calculation of two PHs. In some embodiments, the power limitation comprises first threshold power for the panel 125-1 and second threshold power for the panel 125-2.

In some embodiments, the terminal device 120 may determine first PH for the panel 125-1 based on the first threshold power and transmission power of a first UL transmission via the panel 125-1. For example, the first PH may be determined by equation (18) below.

$$PH 1 = {\tilde{P}}_{cMAX , Panel 1} - {\tilde{P}}_{Panel 1} \qquad ( 18 )$$

where PH1 denotes a PH for panel 1, \tilde{P}_{cMAX, Panel 1} denotes threshold power for panel 1, and \tilde{P}_{Panel1} denotes transmission power of reference transmission of panel 1.

Similarly, the terminal device 120 may determine second PH for the panel 125-2 based on the second threshold power and transmission power of a second UL transmission via the panel 125-2. For example, the second PH may be determined by equation (19) below.

$$PH 2 = {\tilde{P}}_{cMAX , Panel 2} - {\tilde{P}}_{Panel 2} \qquad ( 19 )$$

where PH2 denotes a PH for panel 2, \tilde{P}_{cMAX, Panel2} denotes threshold power for panel 2, and \tilde{P}_{Panel2} denotes transmission power of reference transmission of panel 2.

Then the terminal device 120 may report the first PH and the second PH. It is to be understood that equations (18) and (19) are merely examples, and any other suitable forms are also feasible.

### Cross Panel Power Limitation

In some embodiments where cross panel power limitation is used, one threshold power may be provided for calculation of two PHs for STxMP, and a sum of Tx RS from two panels may need to be deduced. In some embodiments, the power limitation comprises threshold power for the panels 125-1 and 125-2.

In some embodiments, the terminal device 120 may determine PH for the UL transmission based on the threshold power and a sum of transmission power of a first reference transmission via the panel 125-1 and transmission power of a second reference transmission via the panel 125-2. For example, the PH may be determined by equation (20) below.

$$PH ’ = {\tilde{P}}_{cMAX} - ( {\tilde{P}}_{Panel 1} + {\tilde{P}}_{Panel 2} ) \qquad ( 20 )$$

where PH′ denotes a PH for reference transmission, \tilde{P}_{cMAX} denotes configured threshold power, \tilde{P}_{Panel1} denotes transmission power of reference transmission of panel 1, and \tilde{P}_{Panel2} denotes transmission power of reference transmission of panel 2.

Then the terminal device 120 may report the PH. It is to be understood that equation (20) is merely an example, and any other suitable forms are also feasible.

In some embodiments, some assumed values for STxMP may be provided. For example, P_{O_NOMINAL,PUSCH, f, c}(0 Or 1) and p0-PUSCH-AlphaSetId=0 or 1, PL_{b, f, c}(q_{d}) is obtained using pusch-PathlossReferenceRS-Id=0 or 1, and l=0 or 1 for panel 1 and panel 2 respectively. In addition, q_{d} may be q_{d,panel1}, q_{d,panel2} respectively, i.e., panel-specific PL RS.

### Embodiment 6

In this embodiment, a condition to trigger a PHR may be updated.

In some embodiments, if a change of path loss estimate for a panel is higher than a threshold (for convenience, also referred to as a first threshold herein), the terminal device 120 may transmit a PHR for UL transmission.

In some embodiments, if a sum of a change of path loss estimate for a first panel (e.g., the panel 125-1) and a change of path loss estimate for a second panel (e.g., the panel 125-2) is higher than a threshold (for convenience, also referred to as a second threshold herein), the terminal device 120 may transmit a PHR for UL transmission.

In this way, accurate PH may be reported to a network.

### Example Implementation of Methods

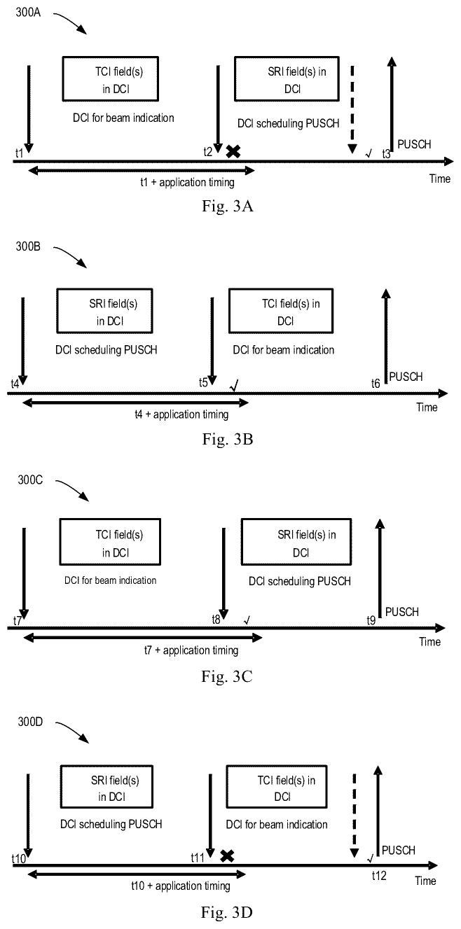

Accordingly, embodiments of the present disclosure provide methods of communication implemented at a terminal device and a network device. These methods will be described below with reference to FIGS. 5 to 7.

FIG. 5 illustrates an example method 500 of communication implemented at a terminal device in accordance with some embodiments of the present disclosure. For example, the method 500 may be performed at the terminal device 120 as shown in FIGS. 1A to 1C. For the purpose of discussion, the method 500 will be described with reference to FIGS. 1A to 1C. It is to be understood that the method 500 may include additional blocks not shown and/or may omit some blocks as shown, and the scope of the present disclosure is not limited in this regard.

At block 510, the terminal device 120 receives a first configuration of a SRS transmission and a second configuration of a PUSCH transmission.

At block 520, the terminal device 120 determines whether a first indication indicating active TCI states and a second indication indicating power control information are received. If the first and second indications are received, the method 500 proceeds to block 530.

At block 530, the terminal device 120 determines one of the first indication and the second indication for use in power control.

At block 540, the terminal device 120 determines first transmission power for the PUSCH transmission based on the first and second configurations and the one of the first indication and the second indication.

In some embodiments, the first configuration comprises first information of a TCI state to be used for power control. In these embodiments, the terminal device 120 may determine the TCI state to be used for power control based on the first information and the first indication; and determine second transmission power for the SRS transmission based on power control information associated with the TCI state.

In some embodiments, the first information comprises at least one of the following: an identity of the TCI state; an association between identities of SRS resource sets and identities of TCI states; an association between identities of SRS resource sets and identities of TRPs or CORESETs or CORESET groups or search space sets and an association between identities of TRPs or CORESETs or CORESET groups or search space sets and identities of TCI states; or a first value of a power control adjustment state, the first value indicating the TCI state to be used for power control.

In some embodiments, the terminal device does not expect different power control configurations provided by the first indication and the second indication. In some embodiments, the first indication and the second indication provide same power control information. In some embodiments, the first configuration comprises first information of a TCI state to be used for power control.

In some embodiments, the first indication has a higher priority than that of the second indication. In some embodiments, the terminal device 120 may ignore power control information indicated by the second indication before an application timing of power control information indicated by the first indication. In some embodiments, the terminal device 120 may override power control information indicated by the second indication with power control information indicated by the first indication before an application timing of power control information indicated by the second indication.

In some embodiments, the second indication has a higher priority than that of the first indication. In some embodiments, the terminal device 120 may ignore power control information indicated by the first indication before an application timing of power control information indicated by the second indication. In some embodiments, the terminal device 120 may override power control information indicated by the first indication with power control information indicated by the second indication before an application timing of power control information indicated by the first indication.

In some embodiments, the terminal device 120 may receive second information comprising at least one of a TCI state to be used for reference signal power determination or a TCI state to be used for a path loss reference signal determination, and determine third transmission power for a PRACH transmission based on the second information.

In some embodiments, if the TCI state to be used for reference signal power determination is associated with a first cell different from a serving cell of the terminal device, the terminal device 120 may obtain the reference signal power from the first cell.

In some embodiments, if no power control parameter setting is provided by a TCI state determined based on the first and second configurations and the one of the first indication and the second indication, the terminal device 120 may determine a power control parameter setting based on at least one of the following: a power control parameter setting associated with a TCI state comprising an identity of a power control configuration; a power control parameter setting having a predetermined identity; or a power control parameter setting applied for a random access procedure within a period of time. In some embodiments, the TCI state comprising the identity of the power control configuration comprises at least one of the following: a TCI state applied to a CORESET associated with the PUSCH transmission; a TCI state applied to a CORESET having a predetermined identity; or a TCI state having a predetermined identity.

In some embodiments, if no path loss reference signal is provided by the TCI state, the terminal device 120 may determine a path loss reference signal based on at least one of the following: a TCI state comprising a configuration of a path loss reference signal; a predetermined path loss reference signal; or a path loss reference signal applied for a random access procedure within a period of time. In some embodiments, the TCI state comprising the configuration of the path loss reference signal comprises at least one of the following: a TCI state applied to a control resource set (CORESET) associated with the PUSCH transmission; a TCI state applied to a CORESET having a predetermined identity; or a TCI state having a predetermined identity. In some embodiments, the predetermined path loss reference signal comprises: a path loss reference signal having a predetermined identity; or a path loss reference signal applied within a period of time.

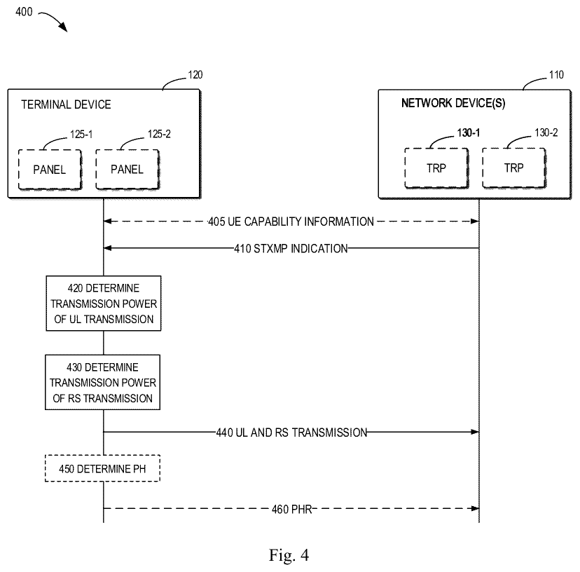

FIG. 6 illustrates an example method 600 of communication implemented at a network device in accordance with some embodiments of the present disclosure. For example, the method 600 may be performed at the network device 110 (the network device 110-1 or 110-2) as shown in FIGS. 1A to 1C. For the purpose of discussion, the method 600 will be described with reference to FIGS. 1A to 1C. It is to be understood that the method 600 may include additional blocks not shown and/or may omit some blocks as shown, and the scope of the present disclosure is not limited in this regard.

At block 610, the network device 110 transmits a first configuration of a SRS transmission and a second configuration of a PUSCH transmission.

At block 620, the network device 110 transmits a first indication indicating active TCI states and a second indication indicating power control information.

At block 630, the network device 110 receives the PUSCH transmission transmitted with first transmission power, the first transmission power being determined based on the first and second configurations and the one of the first indication and the second indication.

In some embodiments, the first configuration comprises first information of a TCI state to be used for power control.

In some embodiments, the first information comprises at least one of the following: an identity of the TCI state; an association between identities of SRS resource sets and identities of TCI states; an association between identities of SRS resource sets and identities of TRPs or CORESETs or CORESET groups or search space sets and an association between identities of TRPs or CORESETs or CORESET groups or search space sets and identities of TCI states; or a first value of a power control adjustment state, the first value indicating the TCI state to be used for power control.

In some embodiments, the network device 110 may transmit second information comprising at least one of a TCI state to be used for reference signal power determination or a TCI state to be used for a path loss reference signal determination.

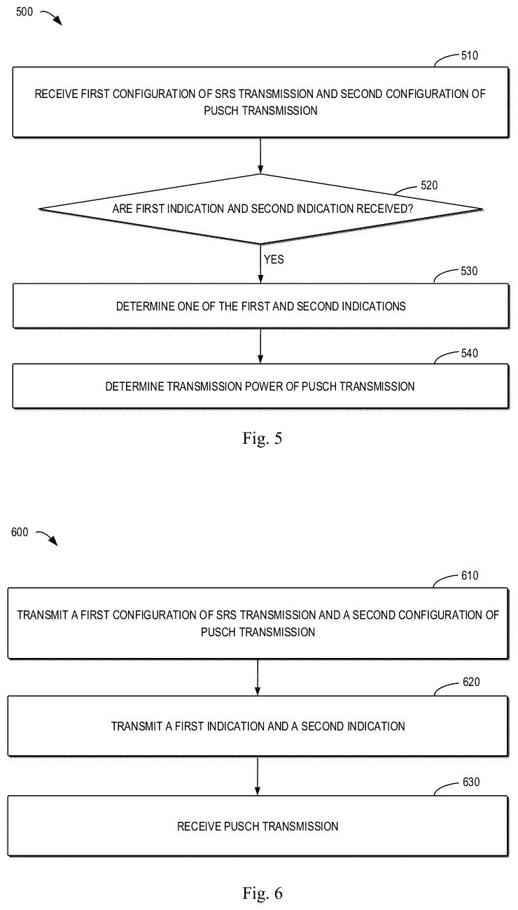

FIG. 7 illustrates another example method 700 of communication implemented at a terminal device in accordance with some embodiments of the present disclosure. For example, the method 700 may be performed at the terminal device 120 as shown in FIGS. 1A to 1C. For the purpose of discussion, the method 700 will be described with reference to FIGS. 1A to 1C. It is to be understood that the method 700 may include additional blocks not shown and/or may omit some blocks as shown, and the scope of the present disclosure is not limited in this regard.

At block 710, the terminal device 120 deployed with first and second panels (e.g., the panels 125-1 and 125-2) receives an indication of simultaneous transmission over the first and second panels.

At block 720, the terminal device 120 determines first transmission power for an uplink transmission based on at least one power limitation for the first and second panels.

At block 730, the terminal device 120 determines second transmission power for a reference signal transmission based on the at least one power limitation, the first transmission power and a ratio of a power related parameter between the uplink transmission and the reference signal transmission, the ratio being determined based on the at least one power limitation.

At block 740, the terminal device 120 performs the uplink transmission with the first transmission power and the reference signal transmission with the second transmission power.

In some embodiments where the power limitation comprises first threshold power for the first panel and second threshold power for the second panel, the terminal device 120 may determine transmission power for the first panel based on the first threshold power; determine transmission power for the second panel based on the second threshold power; and determine the first transmission power based on the transmission power for the first panel and the transmission power for the second panel.

In some embodiments where the power limitation comprises threshold power, the terminal device 120 may determine scaled threshold power based on the threshold power divided by the number of panels; determine, based on the scaled threshold power, transmission power for the first panel; determine, based on the scaled threshold power, transmission power for the second panel; and determine the first transmission power based on the transmission power for the first panel and the transmission power for the second panel.

In some embodiments where the power limitation comprises threshold power, the terminal device 120 may determine transmission power for the first panel and determine transmission power for the second panel. If a sum of the transmission power for the first panel and the transmission power for the second panel is larger than the threshold power, the terminal device 120 may determine scaled transmission power for the first panel based on the transmission power for the first panel and a ratio of the threshold power to the sum, and determine scaled transmission power for the second panel based on the transmission power for the second panel and the ratio of the threshold power to the sum. Then the terminal device 120 may determine the first transmission power based on the scaled transmission power for the first panel and the scaled transmission power for the second panel.

In some embodiments where the reference signal transmission is a DMRS transmission, the terminal device 120 may determine a first PUSCH-to-DMRS power ratio for the first panel based on the number of DMRS CDM groups without data associated with the first panel; determine transmission power for a first DMRS transmission via the first panel based on transmission power for a first uplink transmission via the first panel and the first PUSCH-to-DMRS power ratio; determine a second PUSCH-to-DMRS power ratio for the second panel based on the number of DMRS CDM groups without data associated with the second panel; determine transmission power for a second DMRS transmission via the second panel based on transmission power for a second uplink transmission via the second panel and the second PUSCH-to-DMRS power ratio for the second panel; and determine the second transmission power based on the transmission power for the first DMRS transmission and the transmission power for the second DMRS transmission.

In some embodiments where the reference signal transmission is a DMRS transmission, the terminal device 120 may determine whether a set of antenna ports in DMRS CDM groups without data and a set of antenna ports for DMRS transmission are associated with the same panel. If the set of antenna ports in DMRS CDM groups without data and the set of antenna ports for DMRS transmission are associated with different panels, the terminal device 120 may determine an updated number of DMRS CDM groups without data; determine a PUSCH-to-DMRS power ratio based on the updated number of DMRS CDM groups without data; and determine the second transmission power based on the first transmission power and the PUSCH-to-DMRS power ratio.

In some embodiments where the reference signal transmission is a DMRS transmission, and the number of DMRS CDM groups without data is one.

In some embodiments where the reference signal transmission is a PTRS transmission, the terminal device 120 may determine a first number of PUSCH layers assigned to the first panel and a second number of PUSCH layers assigned to the second panel; determine a first PUSCH-to-PTRS power ratio per layer for the first panel based on the first number of PUSCH layers and a second PUSCH-to-PTRS power ratio per layer for the second panel based on the second number of PUSCH layers; determine, based on the first PUSCH-to-PTRS power ratio per layer and the first transmission power, transmission power for a first PTRS transmission via the first panel; determine, based on the second PUSCH-to-PTRS power ratio per layer and the first transmission power, transmission power for a second PTRS transmission via the second panel; and determine the second transmission power based on the transmission power for the first PTRS transmission and the transmission power for the second PTRS transmission.

In some embodiments where the reference signal transmission is a PTRS transmission, the terminal device 120 may determine the number of PUSCH layers; determine a PUSCH-to-PTRS power ratio per layer per resource element per panel based on the number of PUSCH layers; and determine the second transmission power based on the PUSCH-to-PTRS power ratio per layer per resource element per panel and the first transmission power.

In some embodiments where the power limitation comprises first threshold power for the first panel and second threshold power for the second panel, the terminal device 120 may determine first power headroom for the first panel based on the first threshold power and transmission power of a first uplink transmission via the first panel; determine second power headroom for the second panel based on the second threshold power and transmission power of a second uplink transmission via the second panel; and report the first power headroom and the second power headroom.

In some embodiments where the power limitation comprises threshold power, the terminal device 120 may determine scaled threshold power based on the number of panels and the threshold power; determine first power headroom for the first panel based on the scaled threshold power and transmission power of a first uplink transmission via the first panel; determine second power headroom for the second panel based on the scaled threshold power and transmission power of a second uplink transmission via the second panel; and report the first power headroom and the second power headroom.

In some embodiments where the power limitation comprises threshold power, the terminal device 120 may determine power headroom for the uplink transmission based on the threshold power and a sum of transmission power of a first uplink transmission via the first panel and transmission power of a second uplink transmission via the second panel; and report the power headroom.

In some embodiments where the power limitation comprises first threshold power for the first panel and second threshold power for the second panel, the terminal device 120 may determine transmission power of a first reference transmission via the first panel based on a first set of parameters and transmission power of a second reference transmission via the second panel based on a second set of parameters different from the first set of parameters; determine first power headroom for the first panel based on the first threshold power and the transmission power of the first reference transmission; determine second power headroom for the second panel based on the second threshold power and the transmission power of the second reference transmission; and report the first power headroom and the second power headroom.

In some embodiments where the power limitation comprises threshold power, the terminal device 120 may determine transmission power of a first reference transmission via the first panel based on a first set of parameters and transmission power of a second reference transmission via the second panel based on a second set of parameters different from the first set of parameters; determine power headroom for the uplink transmission based on the threshold power and a sum of the transmission power of the first reference transmission and the transmission power of the second uplink transmission; and report the power headroom.

In some embodiments, if a change of path loss estimate for a panel is higher than a first threshold, the terminal device 120 may transmit a power headroom report for the uplink transmission. In some embodiments, if a sum of a change of path loss estimate for the first panel and a change of path loss estimate for the second panel is higher than a second threshold, the terminal device 120 may transmit a power headroom report for the uplink transmission.

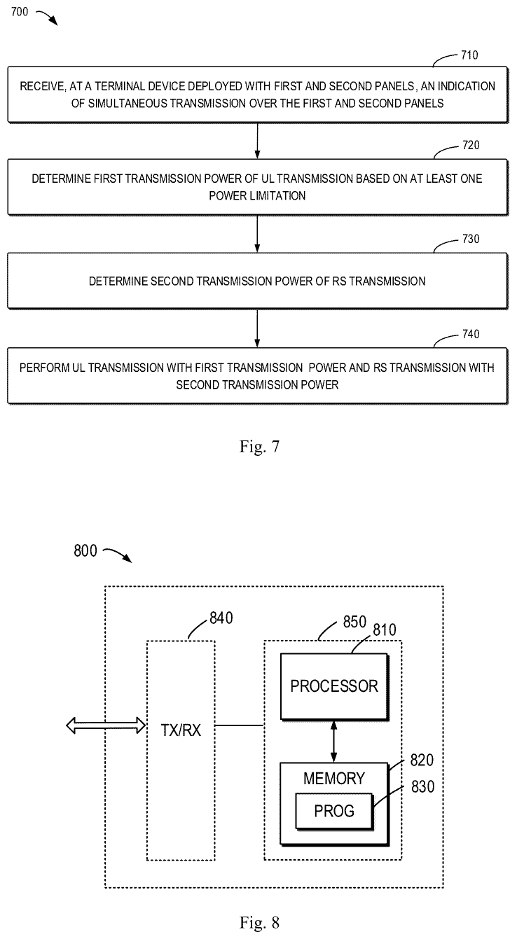

FIG. 8 is a simplified block diagram of a device 800 that is suitable for implementing embodiments of the present disclosure. The device 800 can be considered as a further example implementation of the terminal device 120 and the network devices 110-1 and 110-2 as shown in FIGS. 1A to 1C. Accordingly, the device 800 can be implemented at or as at least a part of the terminal 120 and the network devices 110-1 and 110-2.

As shown, the device 800 includes a processor 810, a memory 820 coupled to the processor 810, a suitable transmitter (TX) and receiver (RX) 840 coupled to the processor 810, and a communication interface coupled to the TX/RX 840. The memory 810 stores at least a part of a program 830. The TX/RX 840 is for bidirectional communications. The TX/RX 840 has at least one antenna to facilitate communication, though in practice an Access Node mentioned in this application may have several ones. The communication interface may represent any interface that is necessary for communication with other network elements, such as X2 interface for bidirectional communications between eNBs, Si interface for communication between a Mobility Management Entity (MME)/Serving Gateway (S-GW) and the eNB, Un interface for communication between the eNB and a relay node (RN), or Uu interface for communication between the eNB and a terminal device.

The program 830 is assumed to include program instructions that, when executed by the associated processor 810, enable the device 800 to operate in accordance with the embodiments of the present disclosure, as discussed herein with reference to FIGS. 1A to 7. The embodiments herein may be implemented by computer software executable by the processor 810 of the device 800, or by hardware, or by a combination of software and hardware. The processor 810 may be configured to implement various embodiments of the present disclosure. Furthermore, a combination of the processor 810 and memory 820 may form processing means 850 adapted to implement various embodiments of the present disclosure.

The memory 820 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 820 is shown in the device 800, there may be several physically distinct memory modules in the device 800. The processor 810 may be of any type suitable to the local technical network, and may include one or more of general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

In some embodiments, a terminal device comprises a circuitry configured to: receive a first configuration of a SRS transmission and a second configuration of a PUSCH transmission; in accordance with a determination that a first indication indicating active TCI states and a second indication indicating power control information are received, determine one of the first indication and the second indication for use in power control; and determine first transmission power for the PUSCH transmission based on the first and second configurations and the one of the first indication and the second indication.

In some embodiments, a network device comprises a circuitry configured to: transmit a first configuration of a SRS transmission and a second configuration of a PUSCH transmission; transmit a first indication indicating active TCI states and a second indication indicating power control information; and receive the PUSCH transmission transmitted with first transmission power, the first transmission power being determined based on the first and second configurations and the one of the first indication and the second indication.

In some embodiments, a terminal device deployed with first and second panels comprises a circuitry configured to: receive an indication of simultaneous transmission over the first and second panels; determine first transmission power for an uplink transmission based on at least one power limitation for the first and second panels; determine second transmission power for a reference signal transmission based on the at least one power limitation, the first transmission power and a ratio of a power related parameter between the uplink transmission and the reference signal transmission, the ratio being determined based on the at least one power limitation; and perform the uplink transmission with the first transmission power and the reference signal transmission with the second transmission power.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1A to 7. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-19. (canceled)

20. A method, performed by a terminal device, the method comprising:
receiving, from a network device, first information of a physical downlink control channel (PDCCH) order, and
determining transmission power of a physical random access channel (PRACH) transmission based on the first information,
wherein the PDCCH order comprises a field indicating a reference signal for path loss estimation for determining the transmission power of the PRACH transmission.

21. The method of claim 20, wherein
the reference signal is among multiple reference signals for the path loss estimation.

22. The method of claim 20, wherein
the PDCCH order is downlink control information (DCI) format 1_0.

23. The method of claim 20, wherein
the PDCCH order further comprises a random access preamble index field, a synchronization signal/physical broadcast channel (SS/PBCH) index field, and a PRACH mask index field.

24. The method of claim 20, wherein
the reference signal corresponds to quasi co-location (QCL) information for the PDCCH order.

25. The method of claim 20, wherein
reference signal power for path loss estimation is obtained from a first cell different from a serving cell, in a case where the PDCCH order is associated with the first cell.

26. The method of claim 20, comprising:
receiving, from the network device, second information comprising a first indication of a transmission configuration indicator (TCI) state and a second indication corresponding to a sounding reference signal resource indicator (SRI), and
determining one of the first indication and the second indication for determining transmission power of a physical uplink shared channel (PUSCH) transmission.

27. The method of claim 26, wherein
the first indication has a higher priority than that of the second indication for determining the transmission power of the PUSCH transmission.

28. A method, performed by a network device, the method comprising:
transmitting, to a terminal device, first information of a physical downlink control channel (PDCCH) order, and
receiving a physical random access channel (PRACH) transmission,
wherein transmission power of the PRACH transmission is determined based on the first information, and
wherein the PDCCH order comprises a field indicating a reference signal for path loss estimation for determining the transmission power of the PRACH transmission.

29. The method of claim 28, wherein
the reference signal is among multiple reference signals for the path loss estimation.

30. The method of claim 28, wherein
the PDCCH order is downlink control information (DCI) format 1_0.

31. The method of claim 28, wherein
the PDCCH order further comprises a random access preamble index field, a synchronization signal/physical broadcast channel (SS/PBCH) index field, and a PRACH mask index field.

32. The method of claim 28, wherein
the reference signal corresponds to quasi co-location (QCL) information for the PDCCH order.

33. The method of claim 28, wherein
reference signal power for path loss estimation is obtained from a first cell different from a serving cell, in a case where the PDCCH order is associated with the first cell.

34. The method of claim 28, comprising:
receiving, from the network device, second information comprising a first indication of a transmission configuration indicator (TCI) state and a second indication corresponding to a sounding reference signal resource indicator (SRI), and
determining one of the first indication and the second indication for determining transmission power of a physical uplink shared channel (PUSCH) transmission.

35. The method of claim 34, wherein
the first indication has a higher priority than that of the second indication for determining the transmission power of the PUSCH transmission.

36. A terminal device, comprising
a memory having program instructions stored therein; and
a processor configured to execute the program instructions that when executed cause the terminal device to perform operations comprising:
receive, from a network device, first information of a physical downlink control channel (PDCCH) order, and
determine transmission power of a physical random access channel (PRACH) transmission based on the first information,
wherein the PDCCH order comprises a field indicating a reference signal for path loss estimation for determining the transmission power of the PRACH transmission.

37. The terminal device of claim 36, wherein
the reference signal is among multiple reference signals for the path loss estimation.

38. The terminal device of claim 36, wherein
the PDCCH order is downlink control information (DCI) format 1_0.

39. The terminal device of claim 36, wherein
the PDCCH order further comprises a random access preamble index field, a synchronization signal/physical broadcast channel (SS/PBCH) index field, and a PRACH mask index field.
